(19) United States
(12) Patent Application Publication
(10) Pub. No.: US 2026/0102746 A1
(43) Pub. Date: Apr. 16, 2026

(54) EXHAUST TREATMENT DEVICE

(71) Applicant: Donaldson Company, Inc., Bloomington, MN (US)

(72) Inventors: Naveen Sridharan, Brussels (BE); Mariusz Pietrzyk, Agneaux (FR); Francisco Silva, Tienen (BE); Bavo Follon, Wijgmaal (BE)

(73) Assignee: Donaldson Company, Inc., Bloomington, MN (US)

(21) Appl. No.: 19/358,898

(22) Filed: Oct. 15, 2025

Related U.S. Application Data
(60) Provisional application No. 63/707,373, filed on Oct. 15, 2024.

(51) Int. Cl. B01F 25/314; B01D 53/94; B01F 23/213; B01F 25/10; B01F 25/421; F01N 3/20; F01N 3/28

(52) U.S. Cl. CPC B01F 25/3141; B01D 53/94; B01F 23/2132; B01F 25/103; B01F 25/4231; F01N 3/2066; F01N 3/2892; B01D 2259/4566; F01N 2610/02; F01N 2610/03; F01N 2610/1453

(57) ABSTRACT

An exhaust treatment device includes an outer conduit, a divider baffle, a dosing conduit, and a restrictor arrangement. The outer conduit defines a length between a first end and a second end. The outer conduit includes a perimetrical wall that defines an interior space and extends from the first end to the second end. A longitudinal axis extends centrally through the interior space from the first end to the second end. The outer conduit includes an injector mounting location. The outer conduit includes an upstream portion and a downstream portion. The divider baffle is positioned within the interior space at an intermediate location between the upstream portion and the downstream portion. The divider baffle defines first, second, and third openings that connect the upstream portion with the downstream portion. The dosing conduit is positioned within the interior space in the upstream portion. The restrictor arrangement is positioned in the downstream portion.

### CROSS-REFERENCE TO RELATED APPLICATION(S)

This application claims the benefit of and priority to U.S. Provisional Application Serial No. 63/707373, filed Oct. 15, 2024, the disclosure of which is hereby incorporated by reference in its entirety.

### BACKGROUND

Vehicles equipped with diesel engines typically include exhaust systems that have aftertreatment components such as selective catalytic reduction catalyst devices, lean NOx catalyst devices, or lean NOx trap devices to reduce the amount of undesirable gases, such as nitrogen oxides (NOx) in the exhaust. In order for these types of aftertreatment devices to work properly, a doser injects reactants, such as urea, ammonia, or hydrocarbons, into the exhaust gas. As the exhaust gas and reactants flow through the aftertreatment device, the exhaust gas and reactants convert the undesirable gases, such as NOx, into more acceptable gases, such as nitrogen, oxygen, or carbon dioxide, or into water. However, the efficiency of the aftertreatment system depends upon how evenly the reactants are mixed with the exhaust gases. There is still a need for exhaust treatment devices that are compact and that provide more efficient and effective mixing of reactants.

### SUMMARY

In general terms, this disclosure is directed to an exhaust treatment device. In certain embodiments, and by non-limiting example, the exhaust treatment device includes an outer conduit, a divider baffle, a dosing conduit, and a restrictor arrangement. The outer conduit defines a length between a first end and a second end. The outer conduit includes a perimetrical wall that defines an interior space. The perimetrical wall extends along the length from the first end to the second end. A longitudinal axis extends centrally through the interior space from the first end to the second end. The outer conduit includes an injector mounting location. The outer conduit includes an upstream portion and a downstream portion. The divider baffle is positioned within the interior space at an intermediate location between the upstream portion and the downstream portion. The divider baffle defines first, second, and third openings that connect the upstream portion with the downstream portion. The dosing conduit is positioned within the interior space in the upstream portion. The dosing conduit extends between a first duct end and a second duct end at an angle relative to the longitudinal axis. The second duct end connects to the first opening of the divider baffle. The restrictor arrangement is positioned in the downstream portion. The restrictor arrangement restricts exhaust airflow as the exhaust airflow travels through the outer conduit.

In some certain embodiments, and by non-limiting example, an exhaust treatment device includes an outer conduit that defines a length between a first end and a second end. The outer conduit includes a perimetrical wall that defines an interior space and extends along the length from the first end to the second end. A longitudinal axis extends centrally through the interior space from the first end to the second end. The outer conduit includes an injector mounting location. The outer conduit includes an upstream portion and a downstream portion. A divider baffle is positioned within the interior space at an intermediate location between the upstream portion and the downstream portion. A dosing conduit is positioned within the interior space in the upstream portion. The dosing conduit extends between a first duct end and a second duct end at an angle relative to the longitudinal axis. The second duct end connects to a first fluid pathway of the divider baffle. A restrictor arrangement is positioned in the downstream portion. The restrictor arrangement restricts exhaust airflow as the exhaust airflow travels through the outer conduit. A swirl member is positioned between the divider baffle and the restrictor arrangement. The swirl member includes a plurality of openings. At least a majority of the plurality of openings are positioned on a first side of a central plane extending though the longitudinal axis.

In some certain embodiments, and by non-limiting example, an exhaust treatment device includes an outer conduit that defines a length between a first end and a second end. The outer conduit includes a perimetrical wall that defines an interior space and extends along the length from the first end to the second end. A longitudinal axis extends centrally through the interior space from the first end to the second end. The outer conduit includes an injector mounting location. The outer conduit includes an upstream portion and a downstream portion. A divider baffle is positioned within the interior space at an intermediate location between the upstream portion and the downstream portion. A dosing conduit is positioned within the interior space in the upstream portion. The dosing conduit extends between a first duct end and a second duct end at an angle relative to the longitudinal axis. The second duct end connects to a first fluid pathway of the divider baffle. A swirl member is positioned between the divider baffle and the restrictor arrangement. The swirl member includes a plurality of openings. The swirl member includes a step such that the plurality of openings is offset relative to an edge region. A restrictor arrangement is positioned in the downstream portion. The restrictor arrangement restricts exhaust airflow as the exhaust airflow travels through the outer conduit. The restrictor arrangement includes a rim about a perimeter of the restrictor arrangement. The rim of the restrictor arrangement forms a close fit with the step of the swirl member such that the restrictor arrangement is at least partially retained by the interface between the step and the rim.

In some certain embodiments, and by non-limiting example, an exhaust treatment system includes an outer conduit that extends along a longitudinal axis. A divider baffle is disposed within the outer conduit. The divider baffle separates the outer conduit into an upstream portion and a downstream portion. A first fluid pathway extends through the divider baffle between the upstream and downstream portions. The first fluid pathway passes through a first set of turbulence generating members. A second fluid pathway extends through the divider baffle between the upstream and downstream portions separate from the first fluid pathway. The second fluid pathway bypasses the turbulence generating members. A third fluid pathway extends through the divider baffle between the upstream and downstream portions separate from the first and second fluid pathways. The third fluid pathway passes through a second set of turbulence generating members. The second set is different from the first set. The first, second, and third fluid pathways combine at the downstream portion.

### BRIEF DESCRIPTION OF THE DRAWINGS

FIG. 1 is a perspective view of an example exhaust treatment device in accordance with the principles of the present disclosure.

FIG. 2 is an exploded perspective view of the exhaust treatment device of FIG. 1.

FIG. 3 is a cross-sectional view of the exhaust treatment device of FIG. 1.

FIG. 4 is another cross-sectional view of the exhaust treatment device of FIG. 1.

FIG. 5 is a front view of an example swirl member in accordance with the principles of the present disclosure.

FIG. 6 is a perspective view of an example divider baffle in accordance with the principles of the present disclosure.

FIG. 7 is a front view of the divider baffle of FIG. 6.

FIG. 8 is a side view of the divider baffle of FIG. 6.

FIG. 9 is a front view of an example dosing conduit in accordance with the principles of the present disclosure.

FIG. 10 is a cross-sectional perspective view of the dosing conduit of FIG. 9.

FIG. 11 is a top view of the dosing conduit of FIG. 9.

FIG. 12 is a cross-sectional perspective view of another example exhaust treatment device in accordance with the principles of the present disclosure.

FIG. 13 is a perspective view of another example divider baffle in accordance with the principles of the present disclosure.

FIG. 14 is a front view of the divider baffle of FIG. 13.

FIG. 15 is a side view of the divider baffle of FIG. 13.

FIG. 16 is a cross-sectional perspective view of another example exhaust treatment device in accordance with the principles of the present disclosure.

FIG. 17 is a perspective view of another example divider baffle in accordance with the principles of the present disclosure.

FIG. 18 is a front view of the divider baffle of FIG. 17.

FIG. 19 is a side view of the divider baffle of FIG. 17.

FIG. 20 is a perspective view of another example exhaust treatment device in accordance with the principles of the present disclosure.

FIG. 21 is an exploded perspective view of the exhaust treatment device of FIG. 20.

FIG. 22 is a cross-sectional perspective view of the exhaust treatment device of FIG. 20.

FIG. 23 is a front view of an example swirl member in accordance with the principles of the present disclosure.

FIG. 24 is a perspective view of an example divider baffle in accordance with the principles of the present disclosure.

FIG. 25 is a front view of the divider baffle of FIG. 24.

FIG. 26 is a side view of the divider baffle of FIG. 24.

FIG. 27 is a perspective view of an example impact surface in accordance with the principles of the present disclosure.

FIG. 28 is a top view of the impact surface of FIG. 27.

FIG. 29 is a perspective view of another example exhaust treatment device in accordance with the principles of the present disclosure.

FIG. 30 is a cross-sectional perspective view of the exhaust treatment device of FIG. 29.

FIG. 31 is a perspective view of another example impact surface in accordance with the principles of the present disclosure.

FIG. 32 is a top view of the impact surface of FIG. 31.

FIG. 33 is a perspective view of another example exhaust treatment device in accordance with the principles of the present disclosure.

FIG. 34 is a cross-sectional perspective view of the exhaust treatment device of FIG. 33.

FIG. 35 is a perspective view of another example impact surface in accordance with the principles of the present disclosure.

FIG. 36 is a top view of the impact surface of FIG. 35.

FIG. 37 is a top view of another example of a dosing conduit in accordance with the principles of the present disclosure.

FIG. 38 a top view of another example of a dosing conduit in accordance with the principles of the present disclosure.

FIG. 39 is a top view of another example of a dosing conduit in accordance with the principles of the present disclosure.

FIG. 40 is a first perspective view of another example of a swirl member in accordance with the principles of the present disclosure.

FIG. 41 is a second perspective view of the example swirl member of FIG. 40.

FIG. 42 is a first perspective view of another example of a swirl member in accordance with the principles of the present disclosure.

FIG. 43 is a second perspective view of the example swirl member of FIG. 42.

FIG. 44 is a first perspective view of another example of a restrictor arrangement in accordance with the principles of the present disclosure.

FIG. 45 is a second perspective view of the example restrictor arrangement of FIG. 44.

FIG. 46 is a first perspective view of another example of a restrictor arrangement in accordance with the principles of the present disclosure.

FIG. 47 is a second perspective view of the example restrictor arrangement of FIG. 46.

FIG. 48 is a first perspective view of another example of a restrictor arrangement in accordance with the principles of the present disclosure.

FIG. 49 is a second perspective view of the example restrictor arrangement of FIG. 48.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Aspects of the present disclosure relate to exhaust treatment devices adapted for use in treating exhaust gas generated by engines such as diesel engines. In certain examples, exhaust treatment devices in accordance with the principles of the present disclosure can be used to treat exhaust generated by diesel engines of vehicles such as over-the-road trucks, off-road vehicles (e.g., agricultural vehicles such as tractors, construction vehicles such as graders, bull-dozers, front end loaders, or other vehicles). Certain aspects of the present disclosure result in an exhaust treatment device that is relatively compact and can be readily mounted under the vehicle hood, under the vehicle cabin, adjacent the vehicle hood, adjacent the vehicle cabin, or elsewhere on the vehicle. In certain examples, exhaust treatment devices in accordance with the principles of the present disclosure can be mounted horizontally, vertically, or at an angle. In certain examples, aspects of the present disclosure relate to exhaust treatment devices with divider baffles having three separate airflow pathways. In certain examples, aspects of the present disclosure relate to differing relative sizes of airflow pathways. In certain examples, the present disclosure relates to exhaust traveling through different airflow pathways at differing angles relative to each other. In certain examples, aspects of the present disclosure relate to exhaust treatment devices with swirl members that include an asymmetric distribution of openings.

Numerous examples of different exhaust treatment devices and different configurations of components are shown in the present disclosure. However, the varying components and varying component designs are intended to be used in customizable assemblies. Therefore, the example exhaust treatment devices shown are not exhaustive, and represent a subset of all the different combinations that may be created with the components shown.

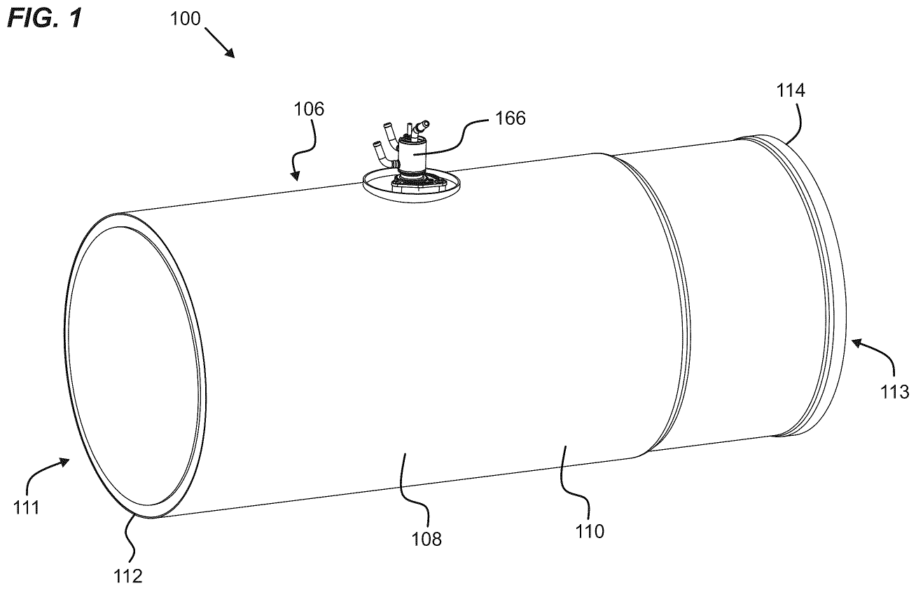

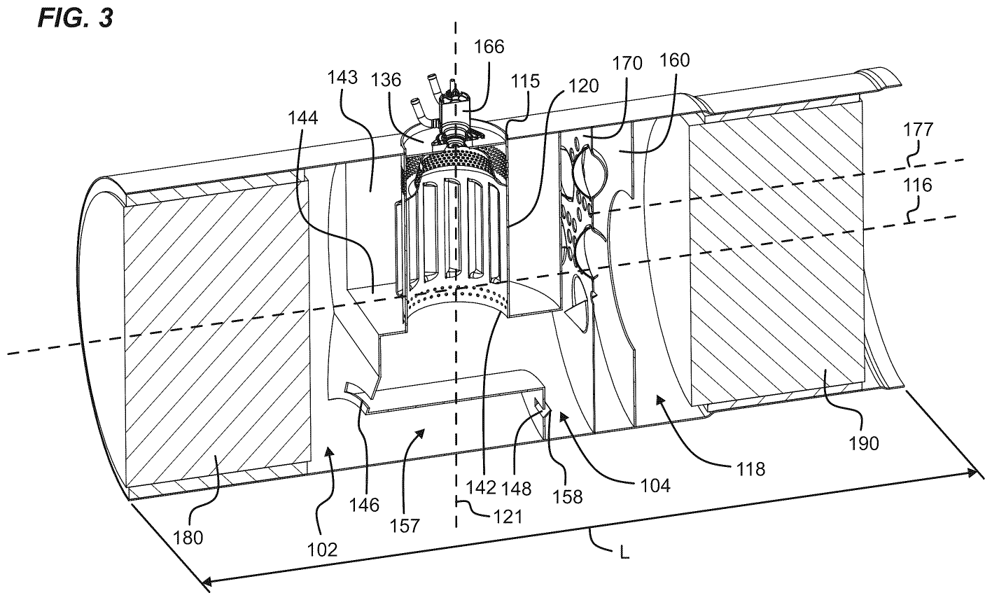

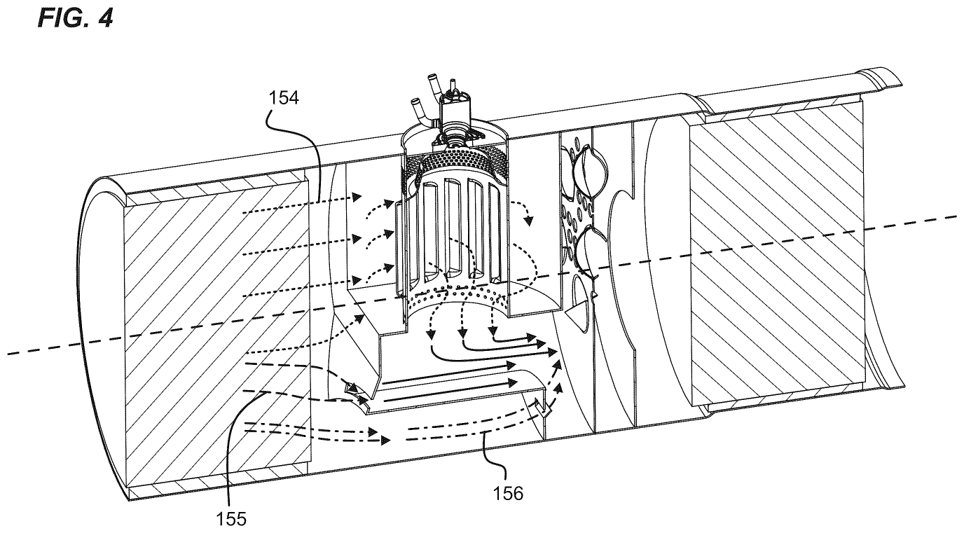

FIGS. 1-4 show an example exhaust treatment device 100 for mixing a liquid spray into a gaseous flow. In certain examples, the exhaust treatment device includes an outer conduit 110, a dosing conduit 120, an injector orifice 136, a divider baffle 140, a restrictor arrangement 160, and a reactant injector 166. In certain examples, the exhaust treatment device also includes a swirl member 170, and/or a substrate 180, and/or a catalyst 190.

In certain examples, the outer conduit 110 includes a first end 112 and a second end 114. The outer conduit extends a length L between the first end and the second end about a longitudinal axis 116. In certain examples, the outer conduit includes a perimetrical wall that extends between the first and second ends 112, 114 and defines an interior space 118. The first end 112 defines an inlet 111 for an exhaust flow and the second end 114 defines an outlet 113 for the exhaust flow. In certain examples, the outer conduit 110 forms a generally cylindrical shell with the length L centered on the longitudinal axis 116. In certain examples, the outer conduit 110 houses at least some of the other components of the exhaust treatment device 100 within the interior space 118.

The divider baffle 140 is positioned within the interior space 118 at an intermediate distance between the first end 112 and the second end 114. The divider baffle 140 separates the exhaust flow between an upstream portion 102 and a downstream portion 104. In certain examples, the entire exhaust flow travels through various fluid pathways defined by the divider baffle 140.

The dosing conduit 120 is positioned within the interior space 118 in the upstream portion 102 and is designed to cause the exhaust gas to swirl about a first swirl axis 121 that is angled relative to the longitudinal axis 116. In certain examples, the first swirl axis 121 is normal to the longitudinal axis 116. A first end 122 of the dosing conduit 120 is mounted to or adjacent a conduit opening 115. In certain examples, the conduit opening 115 defines an injector mounting location. In certain examples, a second end 123 of the dosing conduit 120 is mounted to a first opening 142 of the divider baffle 140. The first opening 142 defines a first fluid pathway 154 between the upstream and downstream portions 102, 104.

In certain examples, the injector orifice 136 is connected to the first end 122 of the dosing conduit 120 and to the conduit opening 115. The injector orifice includes a mounting location for the reactant injector 166 such that the reactant injector 166 is capable of injecting reactant through the first end 122 of the dosing conduit 120.

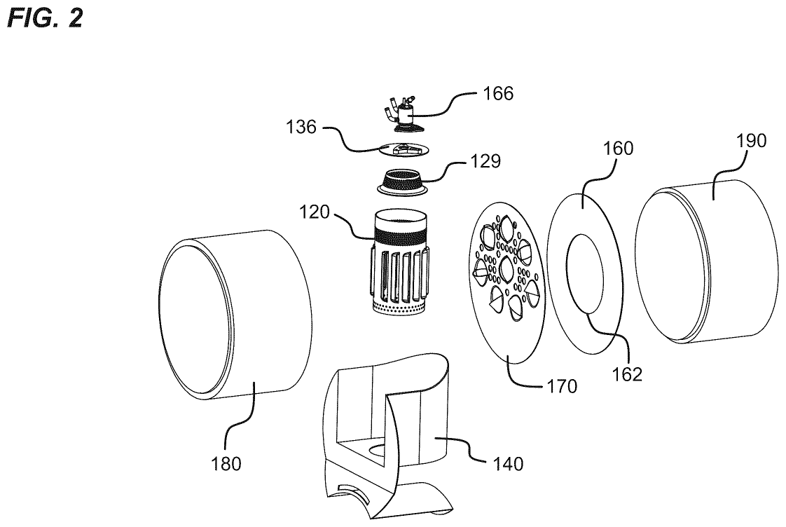

As shown in FIGS. 2-4, the exhaust treatment device 100 also includes the restrictor arrangement 160 and the swirl member 170 in the downstream portion 104. In certain examples, the swirl member 170 regroups the fluid pathways defined by the divider baffle 140 and provides further swirl and turbulence for mixing the reactant with the exhaust. In certain examples, the swirl member 170 is downstream of the divider baffle 140. In certain examples, the swirl member 170 is upstream of the restrictor arrangement 160. In certain examples, the swirl member 170 includes a plurality of openings 172, which may include scoops 173 and/or perforations 174. Other openings are also suitable, such as pipes, louvers, turbulence generating members, or other direction adjusting members that facilitate swirling or other mixing movements of the exhaust.

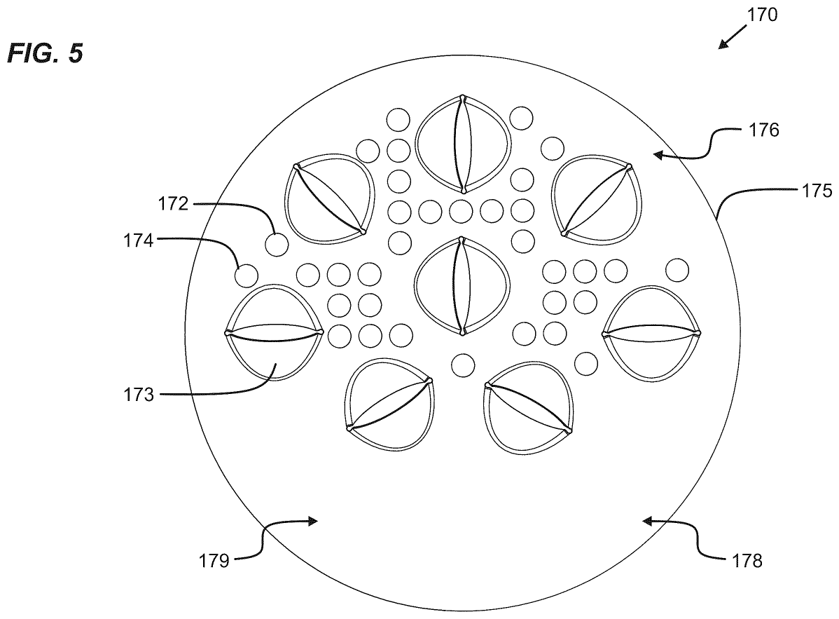

In certain examples, the openings 172 are placed symmetrically about the swirl member. In other examples, as shown in FIG. 5, the openings 172 are asymmetrically placed between an upper portion 176 and a lower portion 178 of the swirl member 170. In certain examples, the openings 172 are asymmetrically placed radially offset from the longitudinal axis 116. In certain examples, the openings 172 swirl the exhaust centered about a second swirl axis 177. The second swirl axis 177 is parallel with but offset from the longitudinal axis 116. In certain examples, a center plane can be defined along the longitudinal axis and extending between first and second sides 106, 108 of the exhaust treatment device 100 where a majority of the openings 172 are on a first side of the plane.

In certain examples, the lower portion 178 includes a solid section 179. In certain examples, the solid section covers between one quarter and one half of the swirl member 170. The solid section 179 provides a restriction of the exhaust by forcing exhaust reaching the swirl member 170 from an upstream side away from a peripheral region of the interior space 118 and away from the lower portion 178.

As shown, the swirl member 170 includes a plurality of scoops 173 with perforations 174 in the space between the scoops 173. In certain examples, the plurality of scoops 173 are arranged such that a subset of scoops 173 are circumferentially spaced about the upper portion 176. In certain examples, there are five circumferential scoops 173 that are equidistant from neighboring circumferential scoops 173 and equidistant from a perimeter 175 of the swirl member 170. In certain examples, a subset of scoops 173 are positioned at an interior of the circumferential scoops 173. In certain examples, there are three interior scoops 173 that are equidistant apart from neighboring interior scoops 173 and are positioned such that two of the three scoops 173 are in the lower portion 178 of the swirl member 170. In certain examples, a majority of the openings 172 are positioned above each of the plurality of fluid pathways such that the exhaust must travel upward after exiting the fluid pathways of the divider baffle 140.

In certain examples, the restrictor arrangement 160 is positioned downstream of the divider baffle 140, between the divider baffle 140 and the second end 114. In certain examples, the restrictor arrangement 160 is positioned downstream of the swirl member 170, spaced apart from the swirl member 170. The restrictor arrangement 160 forces exhaust arriving from an upstream side of the restrictor arrangement 160 to move away from the peripheral region of the interior space 118. In certain examples, the restrictor arrangement 160 includes a central opening 162 centered around the longitudinal axis 116. The exhaust travels through the restrictor arrangement 160 centered on the longitudinal axis 116 of the outer conduit 110.

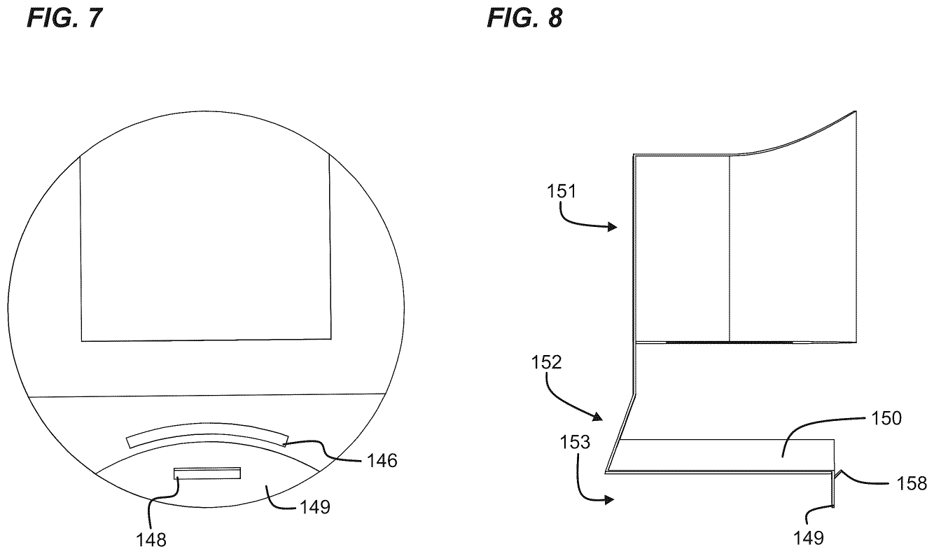

In certain examples, and as shown in FIG. 2 and FIGS. 6-8, the divider baffle has an upstream side and a downstream side. In certain examples, the upstream side includes a swirl pocket 141 which houses the dosing conduit 120. The swirl pocket 141 is formed by a sidewall 143 and a base 144. The base 144 includes the first opening 142 for the dosing conduit 120 to extend to/or through. In certain examples, the sidewall 143 partially surrounds the dosing conduit 120 such that at least a portion of the sidewall 143 is equidistant from the dosing conduit 120 and equidistant from the opening 142. The sidewall 143 extends to an inside surface of the outer conduit 110 in order to prevent exhaust from bypassing the divider baffle 140. In certain examples, a majority of the swirl pocket 141 is positioned in an upper portion of the outer conduit 110.

In certain examples, the divider baffle includes a front face 145 which is a substantially vertical wall extending across an upstream side of the divider baffle 140. The front face forms three distinct sections 151, 152, 153. The front face 145 defines a swirl pocket opening 181, which forms a front of the swirl pocket 141 with the swirl pocket opening 181 being in the first section 151. An angled portion of the front face 145 is positioned below the swirl pocket 141 and includes a second opening 146. The angled portion defines the second section 152. A third section 153 is positioned below the second opening 146 and is offset nearer the second end with an offset wall 149. The offset wall 149 includes a third opening 148. In certain examples, the offset wall 149 is spaced apart from the swirl member such that the swirl member 170 is further downstream than the offset wall.

Connecting the second and third sections 152, 153 is an impact surface 150 where the impact surface 150 is on a downstream side of the divider baffle 140. In certain examples, the impact surface 150 extends parallel with the longitudinal axis 116. The impact surface 150 extends below the first opening 142 and is positioned below the second opening 146. The second opening 146 provides exhaust flow over the impact surface 150 such that buildup of reactant coming from the first opening 142 toward the impact surface 150 is reduced and/or eliminated. In certain examples, the impact surface 150 forms a curved surface where sides of the impact surface 150 extend along the inner surface of the outer conduit 110, parallel with the longitudinal axis 116, and form low points of the curved surface. A high point of the curved surface is centered under the first opening 142. In certain examples, the curved surface has a radius that matches a radius of the perimetrical wall of the outer conduit. In certain examples, the second opening 146 forms a curved slot with a similar or same curved shape as the curved impact surface 150. In certain examples, the third opening 148 forms a fin 158 that opens toward the scoops 173 of the swirl member 170.

In certain examples, the curved shape of the impact surface 150 and the curvature of the outer conduit 110 form a perimeter of the offset wall 149. The third section 153 forms a gap 157 below the impact surface 150 that extends the length of the impact surface 150 to the offset wall 149 and the third opening 148.

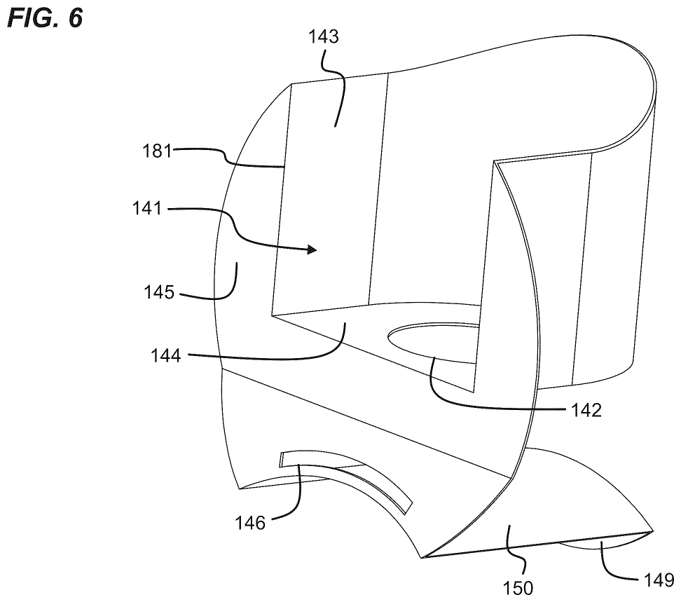

The divider baffle 140 separates the exhaust flow into three different fluid pathways. A first fluid pathway 154 is defined through the first opening 142. A second fluid pathway 155 is defined through the second opening 146. A third fluid pathway 156 is defined through the third opening 148. In certain examples, a majority of the exhaust flows through the first fluid pathway 154 by travelling into the swirl pocket 141, into the dosing conduit 120, and then through the first opening 142. In certain examples, more than 50 percent of the exhaust flows through the first fluid pathway 154. In certain examples, between 50 and 90 percent of the exhaust flows through the first fluid pathway 154. In certain examples, between 70 and 85 percent of the exhaust flows through the first fluid pathway 154. In certain examples, less than 20 percent of the exhaust flows through the second fluid pathway 155. In certain examples, between 10 and 15 percent of the exhaust flows through the second fluid pathway. In certain examples, less than 20 percent of the exhaust flows through the third fluid pathway 156. In certain examples, less than 15 percent of the exhaust flows through the third fluid pathway. In certain examples, between 5 and 15 percent of the exhaust flows through the third fluid pathway 156. As shown in FIG. 6, when the divider baffle 140 is viewed from the front, the divider baffle 140 forms a circular perimeter that matches the inner surface of the outer conduit, thereby forcing the exhaust through the three fluid pathways.

In certain examples, the divider baffle 140 is made from multiple separate pieces. For instance, in certain examples the impact surface 150 and third section 153 may be separate from the rest of the divider baffle 140. In certain examples, the divider baffle 140 is bent or otherwise formed from a single piece of material. In certain examples, the divider baffle is made from metal.

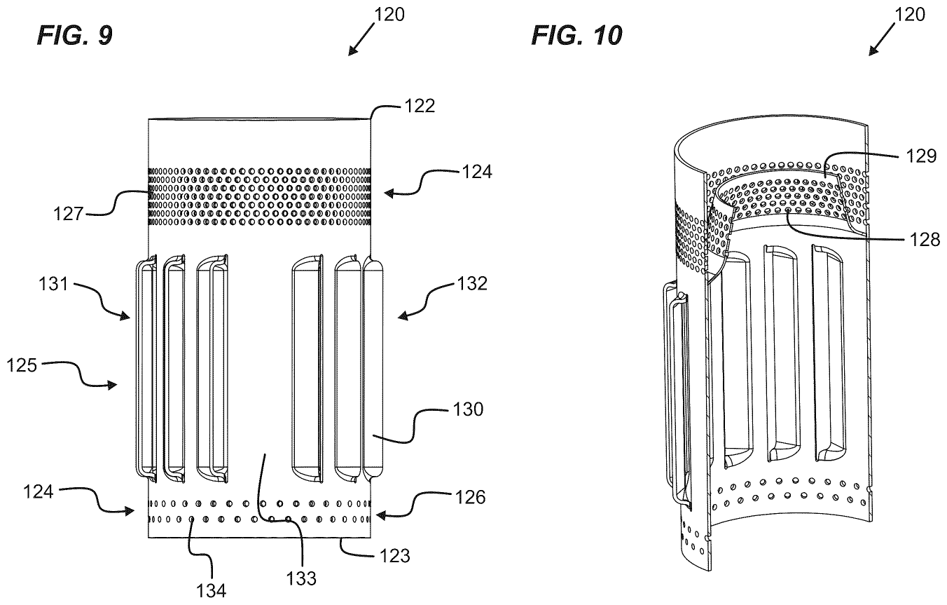

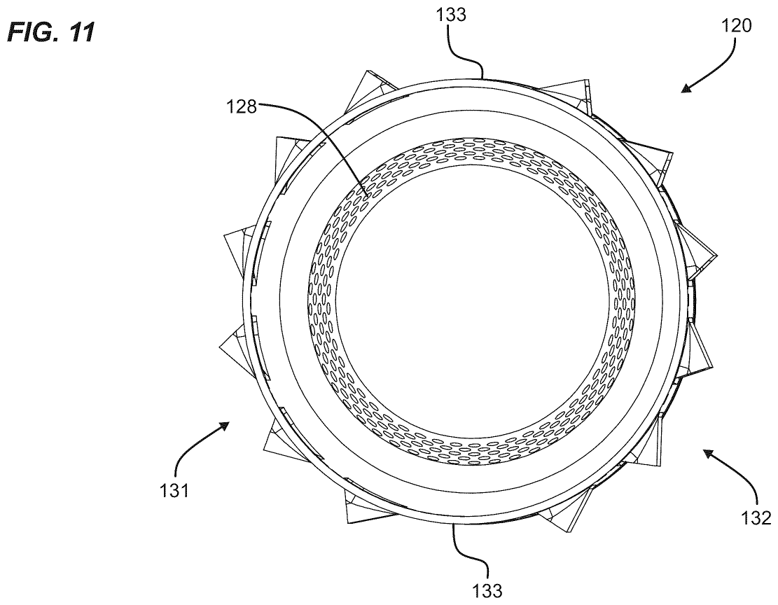

FIGS. 9-11 show an example dosing conduit 120. In certain examples, the dosing conduit forms a cylindrical shell extending along the first swirl axis 121 with a first portion 124, a second portion 125, and a third portion 126. The first portion 124 is adjacent the first end 122 and continues to the second portion. The first portion 124 includes spray protector perforations 127 forming a band circumferentially around the dosing conduit 120. The spray protector perforations 127 may be offset away from the first end 122. In certain examples, the first portion 124 may further include interior perforations 128. The interior perforations 128 may form a second interior band of openings that are at least partially aligned with, but radially inward of, the spray protector perforations 127. The interior perforations are positioned on a frustoconical fin 129 that extends inward and upward from below the spray protector perforations 127 toward the first end 122.

The second portion 125 extends between the first and third portions 124, 126. The second portion 125 includes a plurality of turbulence generating members such as louvers 130 extending an intermediate length between the first end 122 and the second end 123. In certain examples, the louvers 130 form a first group 131 and a second group 132 where the first group 131 is positioned around the dosing conduit 120 on the first side 106 of the exhaust treatment device 100 and the second group 132 is positioned around the dosing conduit 120 on the second side 108 of the exhaust treatment device 100. In certain examples, each of the first and second groups 131, 132 are evenly spaced. In certain examples, each of the first and second groups 131, 132 include six louvers. In certain examples, a space 133 is formed between the first and second groups 131, 132 at a front side of the dosing conduit 120 facing the first end 112 of the outer conduit 110 and a rear side of the dosing conduit 120 facing the second end 114 of the outer conduit 110. In certain examples, the first and second groups of louvers 131, 132 open in the same direction to create uniform rotation within the swirl pocket 141 and through the dosing conduit 120. In certain examples, the louvers 130 are cutout forming sharp edges. In other examples, the louvers 130 are pressed such that ends of each louver are closed.

The third portion 126 extends between the second portion 125 and the second end 123. The third portion 126 includes a band of lower perforations 134 that extend circumferentially around the dosing conduit 120. The third portion 126 connects to the base 144 of the divider baffle 140. In certain examples, the third portion 126 extends through the base such that the second end 123 is in the downstream portion 104.

In certain examples, exhaust travels into the exhaust treatment device 100 from the first end 112 of the outer conduit 110. The exhaust travels through the substrate 180. The exhaust is then split into three fluid pathways 154, 155, 156 where the first fluid pathway 154 is defined by exhaust traveling into the swirl pocket 141, then into the dosing conduit 120, then through the first opening 142. The second fluid pathway 155 is defined by the second opening 146 where exhaust travels through the second opening 146 and over the impact surface 150. The third fluid pathway 156 is defined by exhaust traveling into the gap 157 and through the third opening 148. The exhaust travelling through the first opening 142 is directed towards the impact surface 150 where it joins the exhaust travelling through the second opening 146. The exhaust from the third opening 148 joins the regrouped exhaust from the first and second openings 142, 146 downstream of the first and second openings 142, 146, but before the swirl member 170. The exhaust is then fully regrouped and swirled together by the swirl member 170. Finally, the exhaust travels through the restrictor arrangement 160 and through the catalyst 190 before exiting the exhaust treatment device 100 at the second end 114 of the outer conduit 110.

A number of modifications are possible and described below. For conciseness, same or similar features are not discussed in detail and the description above applies equally to the parts below that have a shared function. It should also be reiterated that the different variations shown below can be mixed and matched with the other components shown in this disclosure. A limited number of variations are shown below as an example of the different possible constructions.

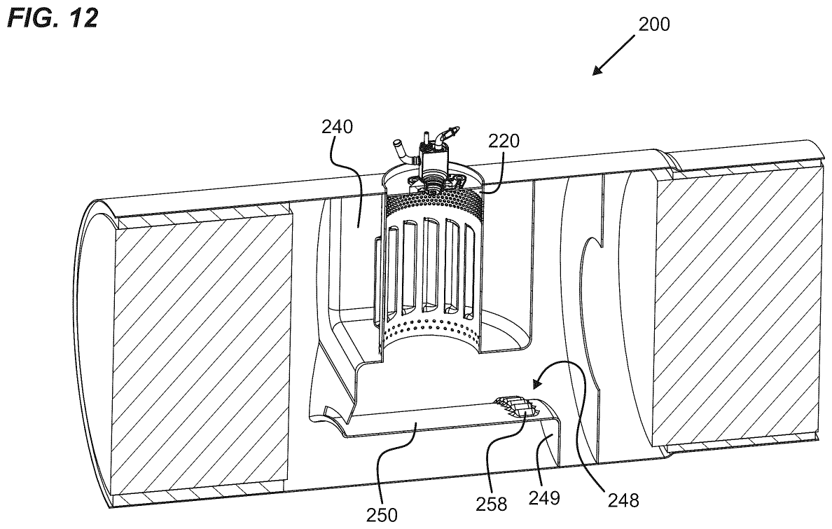

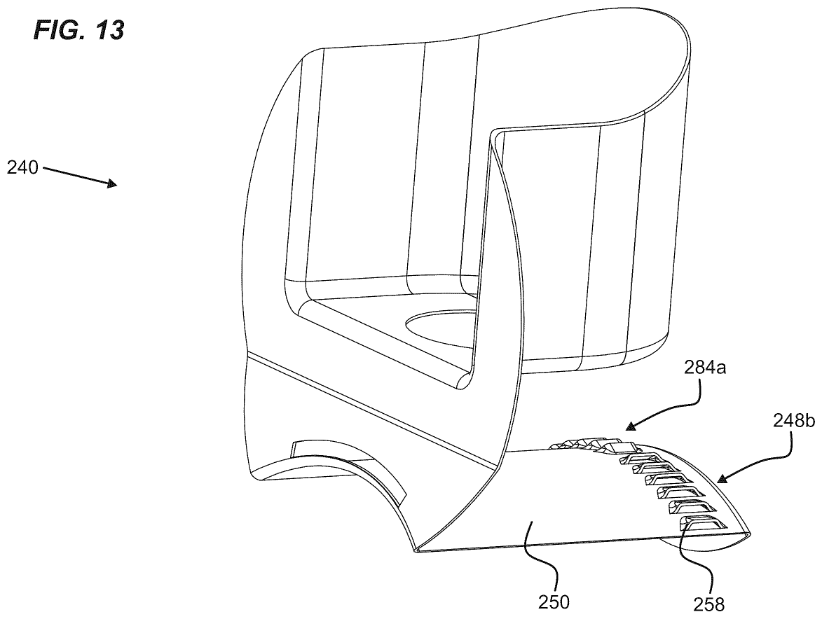

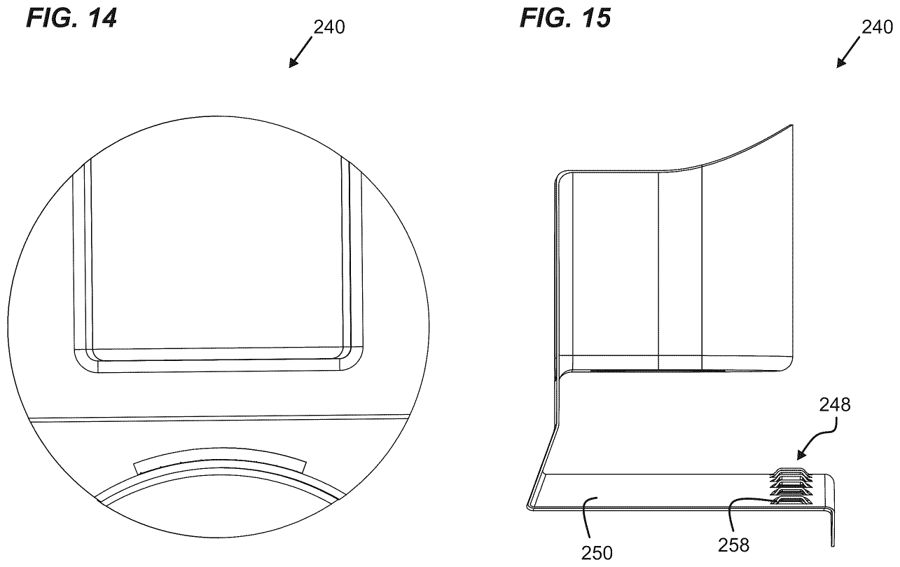

FIG. 12 shows a cross-section of another exhaust treatment device 200. The exhaust treatment device 200 shares many of the features of the exhaust treatment device 100. For that reason, only significant differences are described. For this reason, the same reference numbers are used where components or arrangements of the exhaust treatment device 200 are unchanged from the exhaust treatment device 100. It should be appreciated that aspects of one embodiment may be combined with aspects from other embodiments as many of the individual components described can be used interchangeably. The exhaust treatment device 200 includes a divider baffle 240. As shown in FIGS. 13-15, the divider baffle 240 includes a third opening 248 that is formed by a plurality of turbulence generating members, such as louvers 258. The louvers 258 are positioned on the impact surface 250 near an end of the impact surface where an offset wall 249 is positioned. Notably, the third opening 248 replaces the third opening 148 of the exhaust treatment device 100. Therefore, the offset wall 249 does not have an opening.

Unlike the third fluid pathway 156, the exhaust treatment device 200 includes a third fluid pathway 256 that travels upward through the louvers 258 on the impact surface 250. The louvers 258 of the third opening 248 are divided between a first group 248a and a second group 248b where the first group 248a directs exhaust upward and toward the first side 106 and the second group 248b directs exhaust upward and toward the second side 108. The exhaust treatment device 200 includes three fluid pathways that direct exhaust in three different primary directions. The first fluid pathway 154 directs exhaust downward, the second fluid pathway 155 directs exhaust laterally towards the second end 114, and the third fluid pathway 256 directs exhaust upward. The three fluid pathways meet prior to entering the restrictor arrangement 160. In certain examples, the louvers 258 extend between one tenth and one quarter the length of the impact surface 250. In certain examples, the louvers 258 extend below a portion of the swirl pocket 141. In certain examples, the louvers 258 do not extend below the first opening 142. The exhaust treatment device 200 is also shown without the frustoconical fin 129 and without the swirl member 170. The louvers 258 provide additional mixing over the third opening 148. For this reason, in certain circumstances, the swirl member 170 may not be needed.

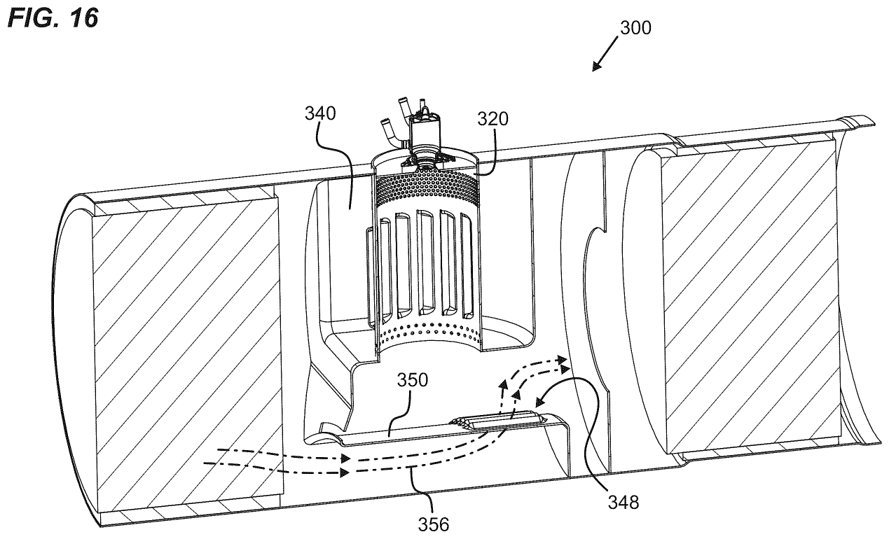

FIG. 16 shows a cross-section of another exhaust treatment device 300. The exhaust treatment device 300 shares many of the features of the exhaust treatment device 100. For that reason, only significant differences are described. Similarly, the same reference numbers are used where components or arrangements of the exhaust treatment device 300 are unchanged from the exhaust treatment device 100. It should be appreciated that aspects of one embodiment may be combined with aspects from other embodiments as many of the individual components described can be used interchangeably The exhaust treatment device 300 includes a divider baffle 340.

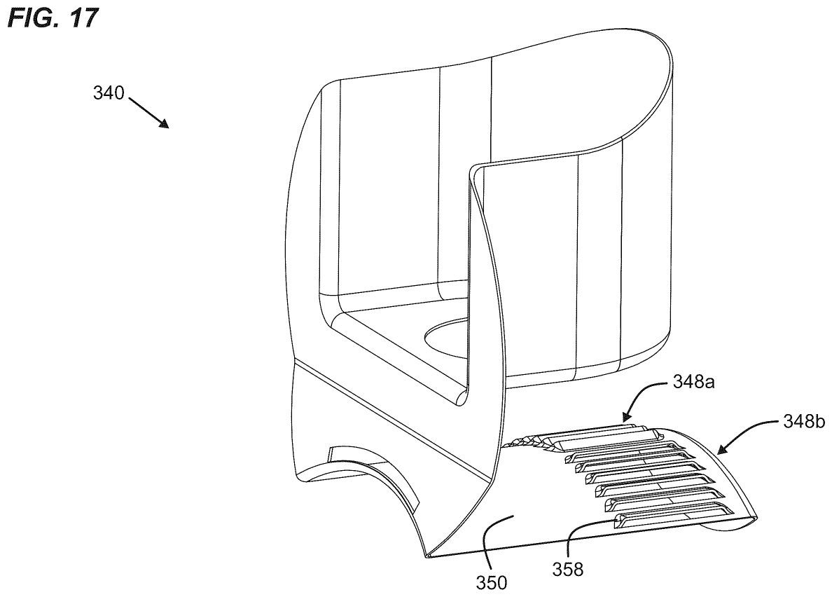

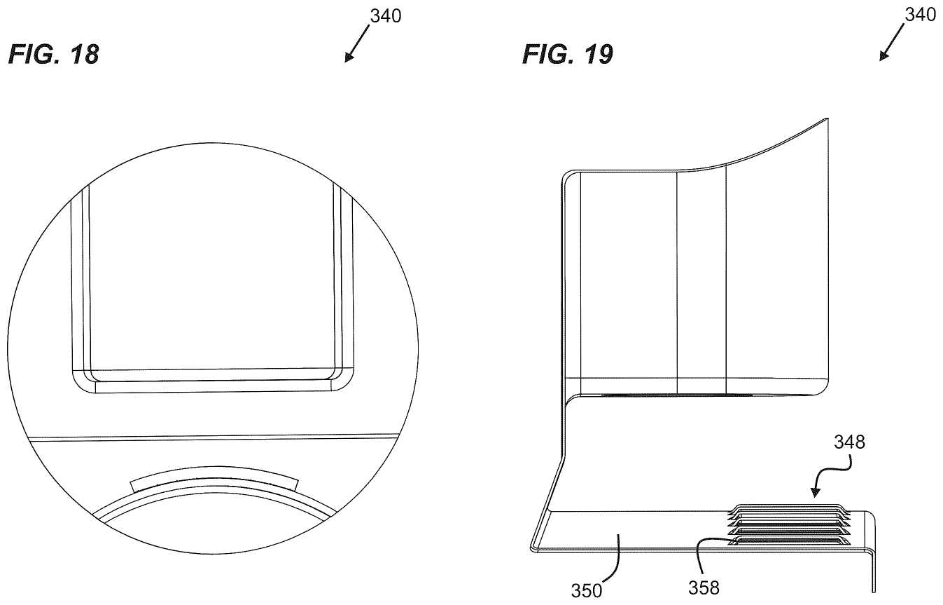

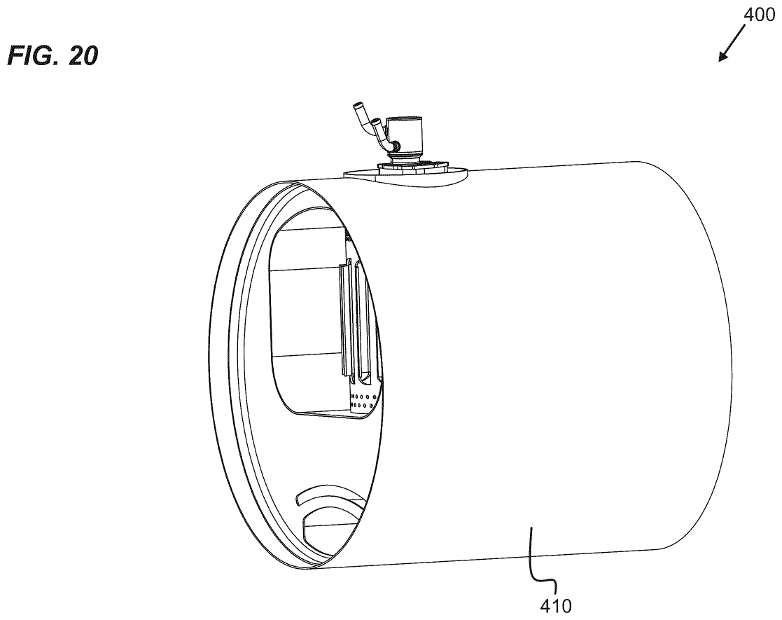

As shown in FIGS. 17-19, the divider baffle 340 includes a third opening 348 that is formed by a plurality of turbulence generating members, such as louvers 358. The louvers 358 are positioned on the impact surface 350 near an end of the impact surface where an offset wall 349 is positioned. Notably, the third opening 348 replaces the third opening 148 of the exhaust treatment device 100. Therefore, the offset wall 349 does not have an opening. Unlike the third fluid pathway 156, the exhaust treatment device 300 includes a third fluid pathway 356 that travels upward through the louvers 358 on the impact surface 350. The louvers 358 of the third opening 348 are divided between a first group 348a and a second group 348b where the first group 348a direct exhaust upward and toward the first side 106 and the second group 348b direct exhaust upward and toward the second side 108.

The exhaust treatment device 300 is also shown without the frustoconical fin 129 and without the swirl member 170. The louvers 358 provide additional mixing over the third opening 148. For this reason, in certain circumstances, the swirl member 170 may not be needed or desired. Notably, the louvers 358 of the exhaust treatment device 300 extend further along the impact surface 350 than the louvers 258 of the exhaust treatment device 200. In certain examples, the louvers 358 extend between one quarter and one half the length of the impact surface. In certain examples, the louvers 358 extend below the swirl pocket 141. In certain examples, the louvers 358 extend below the first opening 142.

FIG. 20 shows another example exhaust treatment device 400. The exhaust treatment device 400 shares many of the features of the exhaust treatment device 100. For that reason, only significant differences are described. Similarly, the same reference numbers are used where components or arrangements of the exhaust treatment device 400 are unchanged from the exhaust treatment device 100. It should be appreciated that aspects of one embodiment may be combined with aspects from other embodiments as many of the individual components described can be used interchangeably

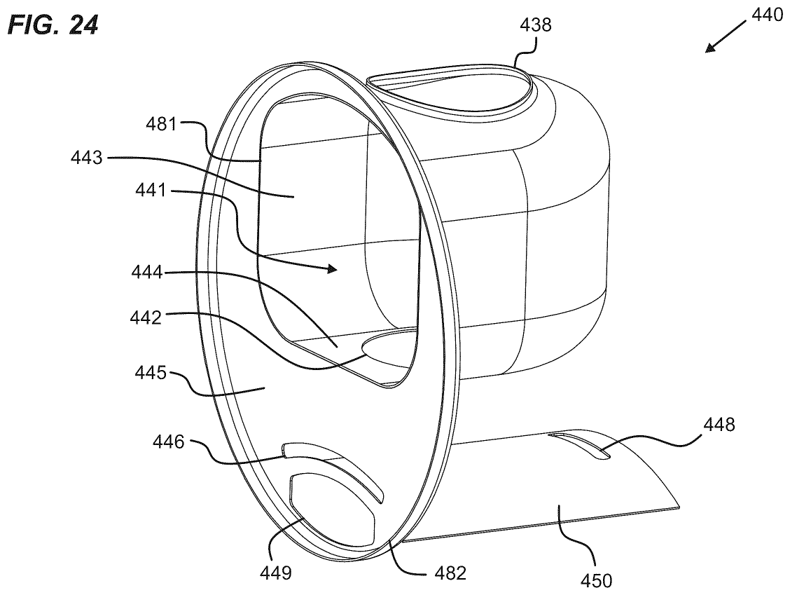

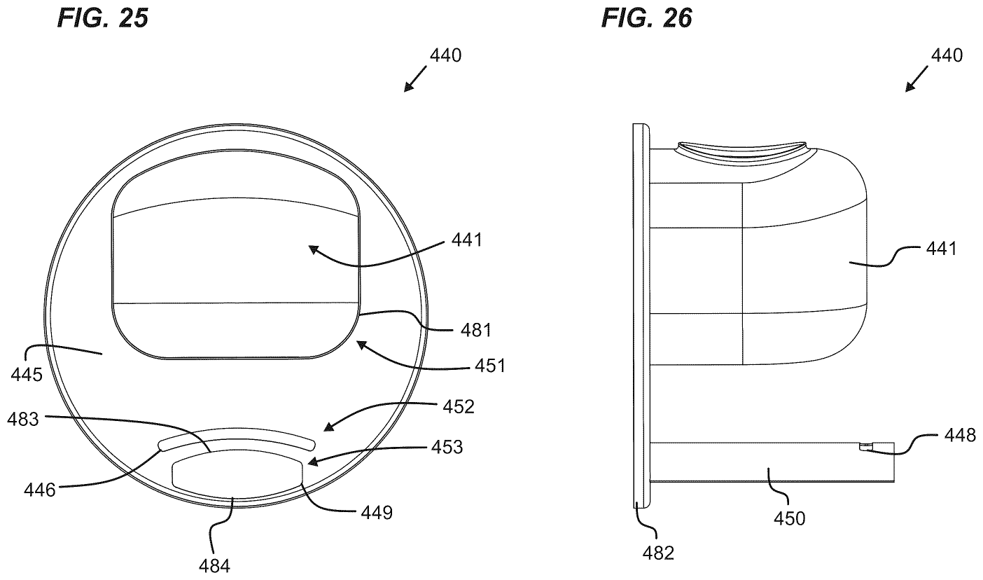

The exhaust treatment device 400 includes a divider baffle 440. An example of the divider baffle 440 is shown on FIGS. 24-26. The divider baffle includes a swirl pocket 441, a front face 445, and an impact surface 450. In certain examples, the components of the divider baffle 440 are separable. The front face 445 includes a swirl pocket opening 481, a second opening 446, and a gap opening 449. The front face 445 defines the entirety of the swirl pocket opening 481, whereas the front face 145 relies on the outer conduit 110 to form a portion of the swirl pocket opening 181. The gap opening 449 restricts the amount of exhaust flow going into a gap 457 below the impact surface 450. The gap opening 449 includes opposing curved major sides 483, 484 that follow the contour of the curved surface of the outer conduit 410 and the impact surface 450 such that the contour of the first major side 483 aligns with the impact surface 450 and the contour of the second major side 484 aligns with a lower portion of the outer conduit 410.

Like the front face 145, the front face 445 includes three sections 451, 452, 453 where the first section 451 includes the swirl pocket opening 481, the second section 452 includes the second opening 446, and the third section 453 includes the gap opening 449. But unlike the front face 145, the front face 445 is entirely flat across the three sections. The front face 445 includes an outer rim 482. In certain examples, the outer rim 482 may seat within a channel or other retaining feature formed in the outer conduit 410.

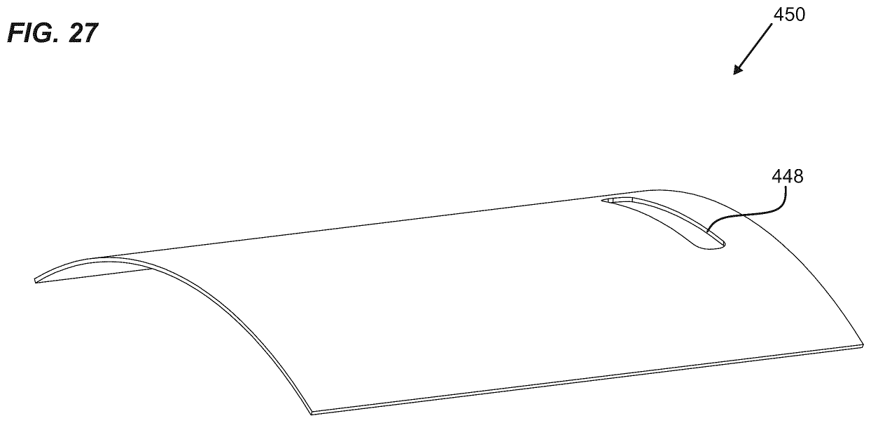

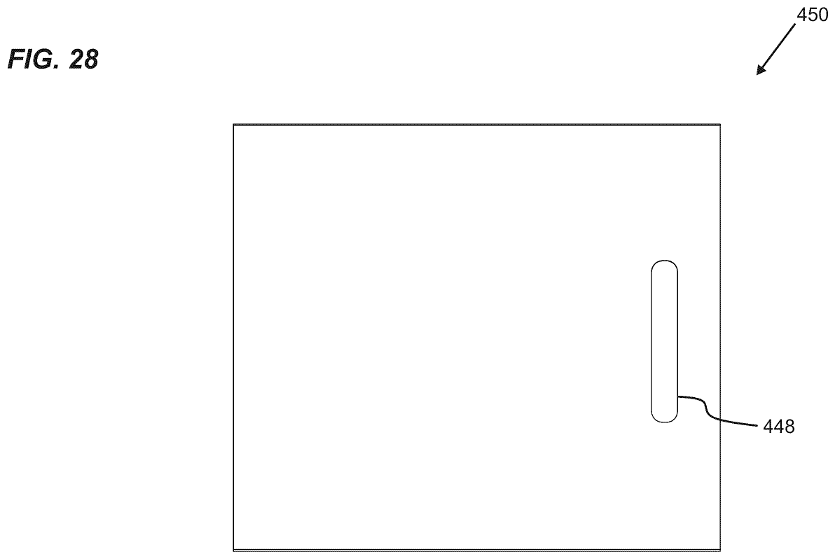

As mentioned before, various different designs for the impact surface 450 may be mixed and matched. An example of the impact surface 450 is shown in FIGS. 27-28. The impact surface 450 includes a third opening 448. The third opening 448 is a singular slot extending normal to the longitudinal axis 116. At least a portion of the third opening 448 is not below the swirl pocket 441. As shown, the impact surface 450 connects to a downstream surface of the front face 445 just below the second opening 448 and connects to the swirl member 470.

The swirl pocket 441 has many similarities to the swirl pocket 141, but the overall shape of the swirl pocket 441 is smoothed to provide improved airflow. The swirl pocket 441 includes a first opening 442 opening through a base 444. The base transitions smoothly, in a curved fashion, into a sidewall 443, where, like the sidewall 144, a significant portion of the sidewall 443 wraps equidistant around the first opening 442. An upper portion of the sidewall 443 curves toward the first end 122 of the dosing conduit 120. The sidewall 443 eventually transitions into a duct opening 438. The duct opening 438 forms a saddle shaped ring, such that two opposing sides of the duct opening are further from an interior surface of the outer conduit 410 than their neighboring sides. The duct opening 438 contacts a perimeter of the dosing conduit 120 in the first portion 124. In certain examples, a securing feature 439 is used to connect the swirl pocket 441 with the swirl member 470.

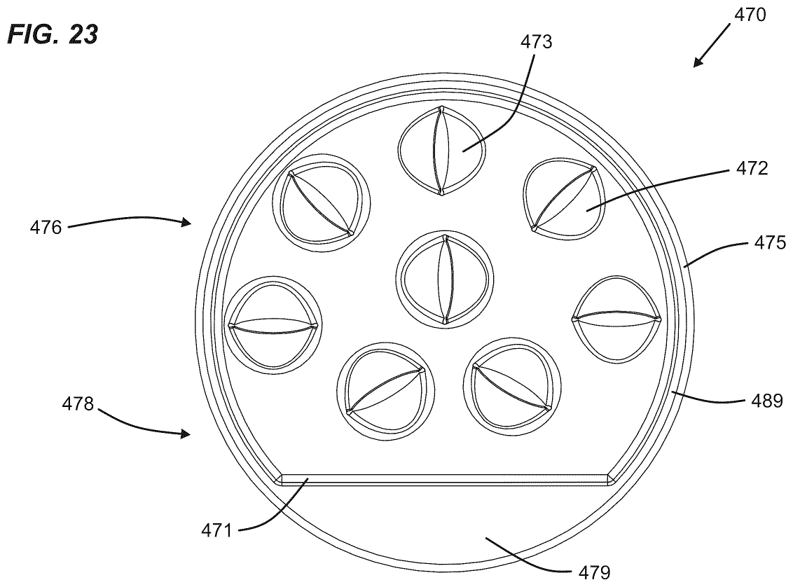

FIG. 23 shows an example swirl member 470 with openings 472. In certain examples, the openings 472 are placed asymmetrically between an upper portion 476 and a lower portion 478 of the swirl member 470. In certain examples, the openings 472 are asymmetrically placed radially offset from the longitudinal axis 116. In certain examples, the openings 472 swirl the exhaust centered about the second swirl axis 177. The second swirl axis 177 is parallel with but offset from the longitudinal axis 116. In certain examples, a center plane can be defined along the longitudinal axis and extending between the first and second sides 106, 108 of the exhaust treatment device 400 where a majority of the openings 472 are on a first side of the plane.

In certain examples, the lower portion 478 includes a solid section 479. In certain examples, the solid section covers between one quarter and one half of the swirl member 470. The solid section 479 provides a restriction of the exhaust by forcing exhaust reaching the swirl member 470 from an upstream side away from a peripheral region of the interior space 118 and away from the lower portion 478.

In certain examples, the swirl member includes a step 471 that surrounds the openings 472 and offsets the openings 472 from the solid surface 479 about the longitudinal axis. In certain examples, the step includes a straight section at the solid surface 479 such that the solid surface is a minor segment of the circular shaped swirl member. An edge region 489 includes a perimeter 475. The edge region 489 may also define a rim to be used to fit within a channel or other retaining feature of the outer conduit 410.

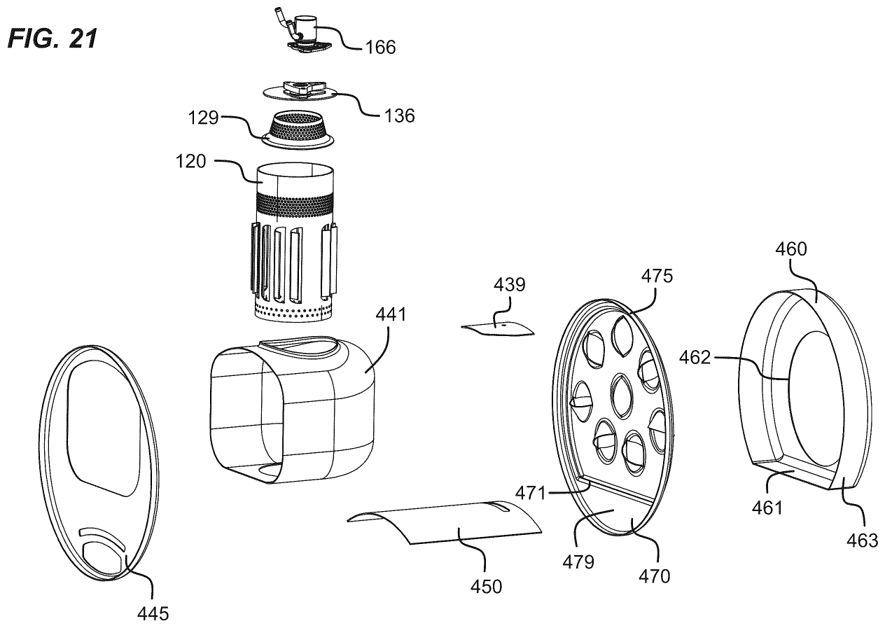

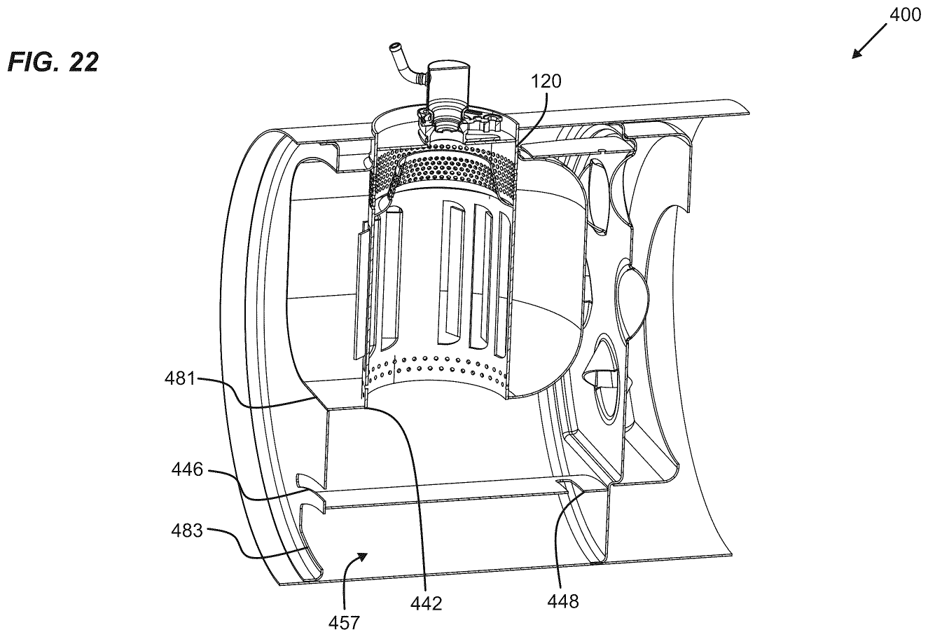

FIG. 21 shows an example restrictor arrangement 460 where the restrictor arrangement is designed to connect to the swirl member 470. The restrictor arrangement includes a rim 463 that forms a perimeter of the restrictor arrangement 460. The rim 463 of the restrictor arrangement 460 forms a close fit with the step 471 of the swirl member 470 such that the restrictor arrangement 460 is at least partially retained by the interface between the step 471 and the rim 463. In certain examples, where the swirl member includes a solid surface that is segment shaped, the restrictor arrangement is circularly shaped with a corresponding segment missing from the circular shape. In certain examples, the restrictor arrangement includes a straight portion 461 of the rim 463. A central opening 462 extends through the restrictor arrangement centered about the longitudinal axis 116. However, the central opening is not centered about the perimeter of the restrictor arrangement defined by the rim 463.

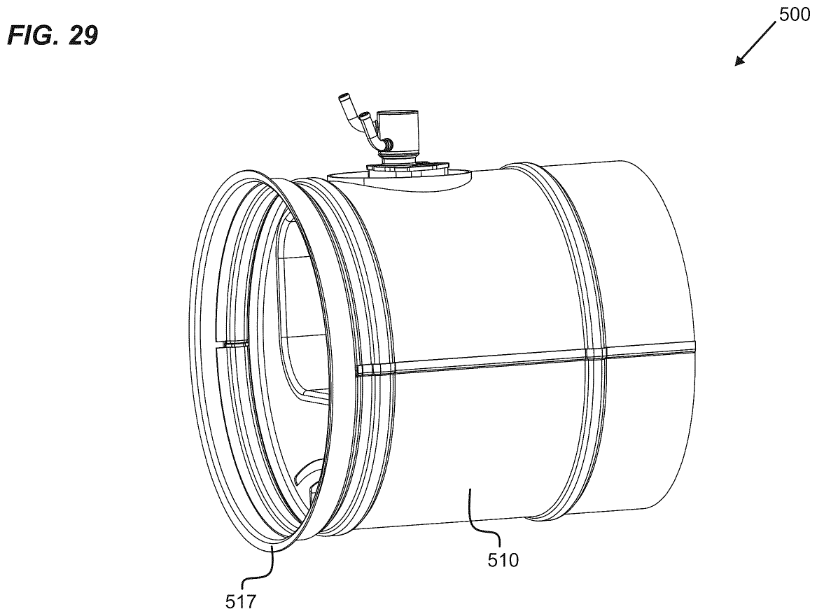

FIG. 29 shows another example exhaust treatment device 500. The exhaust treatment device 500 shares many of the features of the exhaust treatment device 100 and the exhaust treatment device 400. For that reason, only significant differences are described. Similarly, the same reference numbers are used where components or arrangements of the exhaust treatment device 500 are unchanged from the exhaust treatment devices 100, 400. It should be appreciated that aspects of one embodiment may be combined with aspects from other embodiments as many of the individual components described can be used interchangeably The exhaust treatment device 500 includes an outer conduit 510. The outer conduit 510 includes an upstream attachment 517 and a downstream attachment 585. In certain examples, the upstream attachment 517 and/or the downstream attachment 585 are designed to facilitate connection to other components within an exhaust system. The outer conduit 510 also includes first and second channels 519a, 519b. The first channel 519a is designed to engage the outer rim 482 of the front face 445.

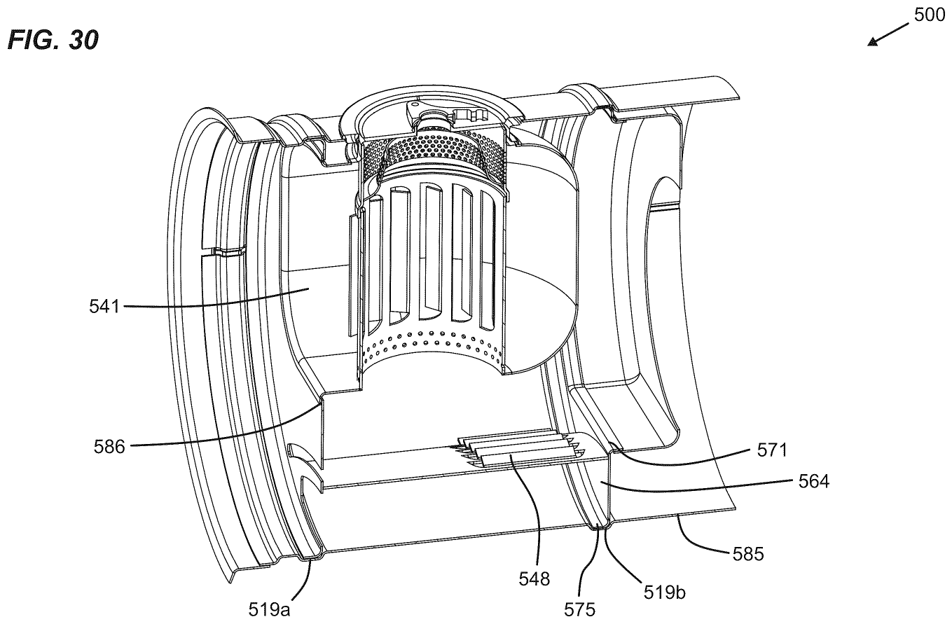

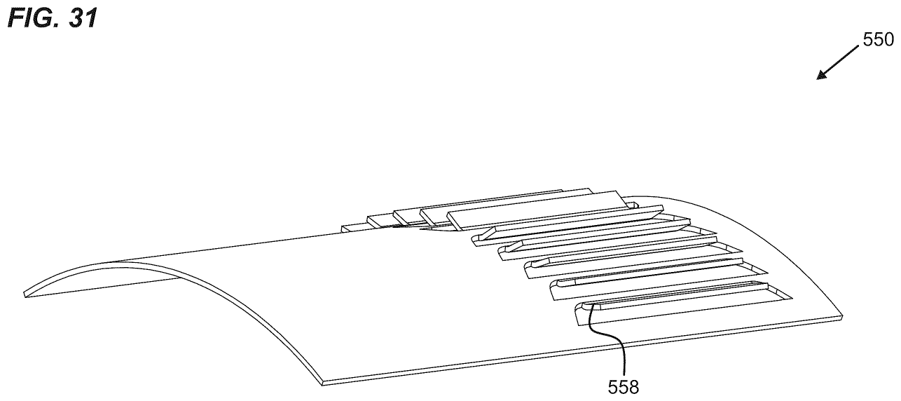

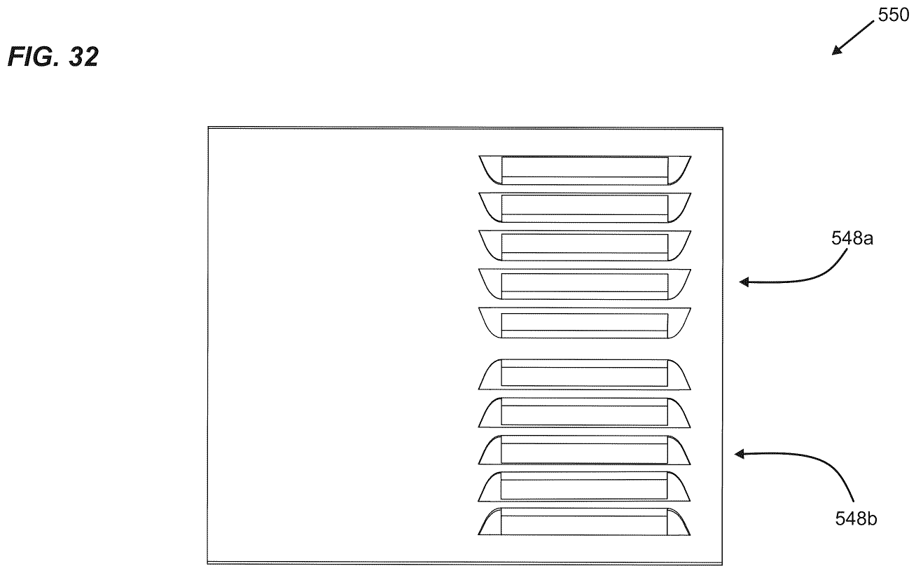

As seen on FIG. 30, a swirl pocket 541 may include a lip 586 that surrounds the swirl pocket opening 481 of the front face 445. Another example impact surface 550 is shown on FIGS. 31-32. The impact surface 550 is the same shape as the impact surface 450 but where a third opening 548 is formed by turbulence generating members, such as louvers 558. The louvers 558 are split into a first group 548a and a second group 548b like the louvers 248a and 248b.

The exhaust treatment device 500 has the same restrictor arrangement as restrictor arrangement 460. However, because the exhaust treatment device 500 does not include a swirl member, a restrictor attachment 564 is used. The restrictor attachment 564 includes a step 571 that is similar to step 471. The restrictor attachment 564 also includes a perimeter 475 that defines a rim. The rim is designed to fit within the second channel 519b.

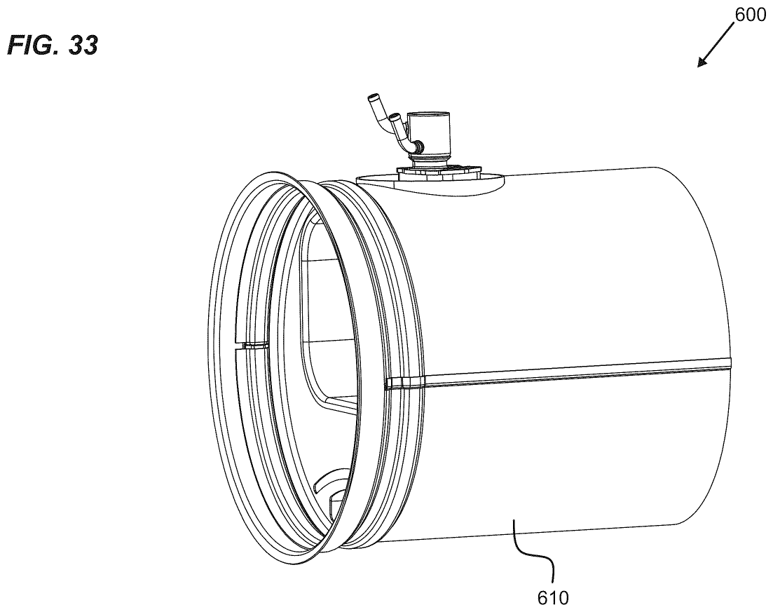

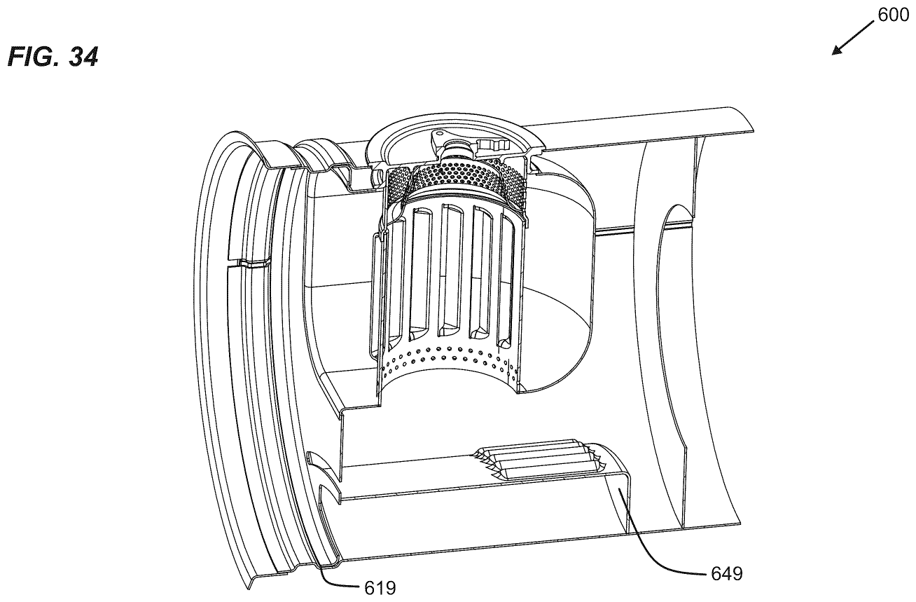

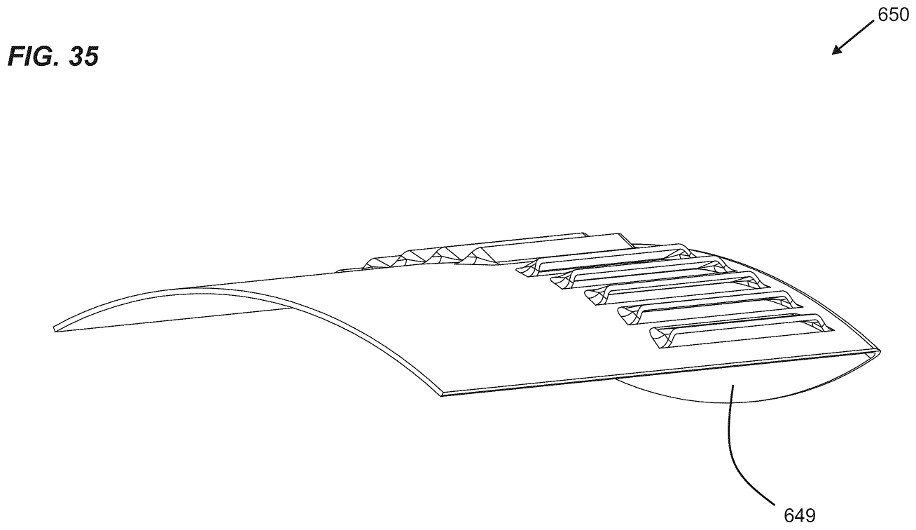

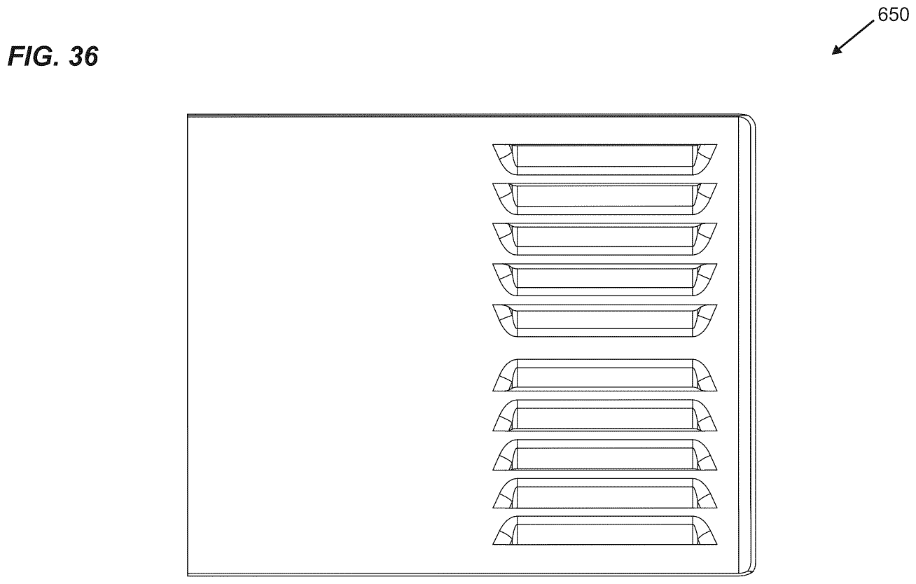

FIG. 33 shows another example exhaust treatment device 600. The exhaust treatment device 600 shares many of the features of the exhaust treatment device 100 and the exhaust treatment device 400. For that reason, only significant differences are described. Similarly, the same reference numbers are used where components or arrangements of the exhaust treatment device 600 are unchanged from the exhaust treatment devices 100, 400. The exhaust treatment device 600 includes an outer conduit 610. The outer conduit 610 includes only a single channel 619 for connecting to the front face 445. The exhaust treatment device 600 also includes an impact surface 650. Like several previously described impact surfaces, the impact surface 650 includes an offset wall 649. The restrictor arrangement of the exhaust treatment device 600 is substantially the same as restrictor arrangement 160 and does not require additional attachment to the outer conduit 610.

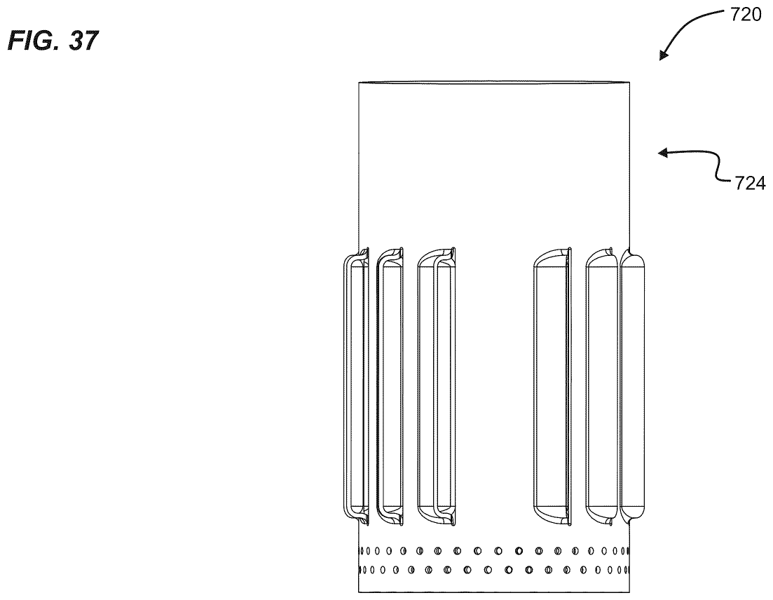

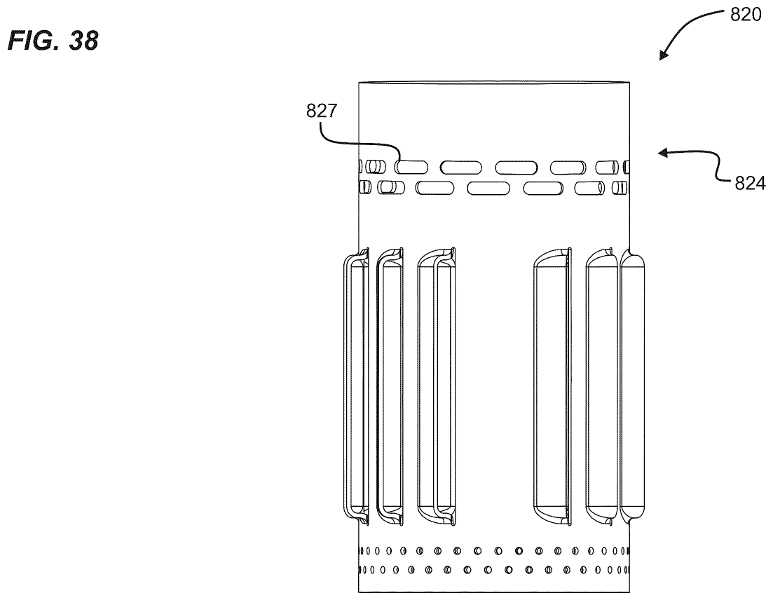

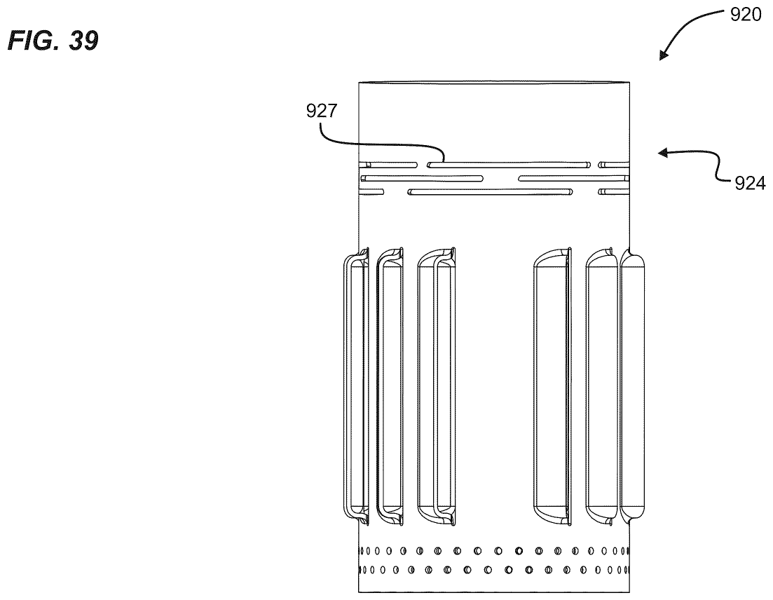

FIGS. 37-39 depict additional variations of dosing conduits that may be used in combination with any of the above-described exhaust treatment devices. FIG. 37 depicts a dosing conduit 720. The dosing conduit 720 does not include perforations in a first portion 724 as compared to dosing conduit 120. FIG. 38 depicts a dosing conduit 820. The dosing conduit 820 includes slots 827 in a first portion 824. The slots 827 extend normal to the first swirl axis 121 circumferentially around the dosing conduit 820. In certain examples the slots 827 form two rows where the slots of a first row partially overlap slots of a second row. FIG. 39 depicts a dosing conduit 920. The dosing conduit 920 includes elongated slots 927 in a first portion 924. The elongated slots 927 extend normal to the first swirl axis 121 circumferentially around the dosing conduit 920. In certain examples the elongated slots 927 form three rows where the elongated slots 927 of a first row partially overlap the elongated slots of each other row. The elongated slots 927 of a second row partially overlap each other row. The elongated slots 927 of a third row partially overlap each other row.

Different swirl members can be used with any of the exhaust treatment devices 100, 200, 300, 400, 500, 600 described above. FIGS. 40-43 depict additional variations of swirl members that may be used in combination with any of the above-described exhaust treatment devices. An example swirl member 770 is shown in FIGS. 40-41. In certain examples, the swirl member 770 defines a plate 771 with a lip 773 along a perimeter 775 of the plate 771. In certain examples, the perimeter 775 is defined around an outside edge of the swirl member 770. In certain examples, the lip 773 defines a rim extending outward from and normal to a face of the plate 771. In certain examples, the lip 773 is designed fit within a channel or other retaining feature of the outer conduit 110, 410, 510.

In certain examples, the swirl member 770 includes a plurality of louvers 772. In certain examples, the plurality of louvers 772 each extend radially outward from a core 774. In certain examples, each of the plurality of louvers 772 are positioned radially outward from the core 774. In certain examples, the plurality of louvers 772 are evenly spaced around the core 774. In certain examples, the core 774 defines a solid portion of the swirl member 770. In certain examples, the core 774 is a circular portion of the swirl member 770. In certain examples, the core 774 is offset from a center of the plate 771 of the swirl member 770. In certain examples, a second swirl axis 777 is defined extending centrally through the core 774. In certain examples, the second swirl axis 777 is parallel with but offset from the longitudinal axis 116. In certain examples, the swirl member 770 defines an upper portion 776 and a lower portion 778. In certain examples, the core 774 is positioned in the upper portion 776. In certain examples, a majority of the plurality of louvers 772 are positioned in the upper portion 776.

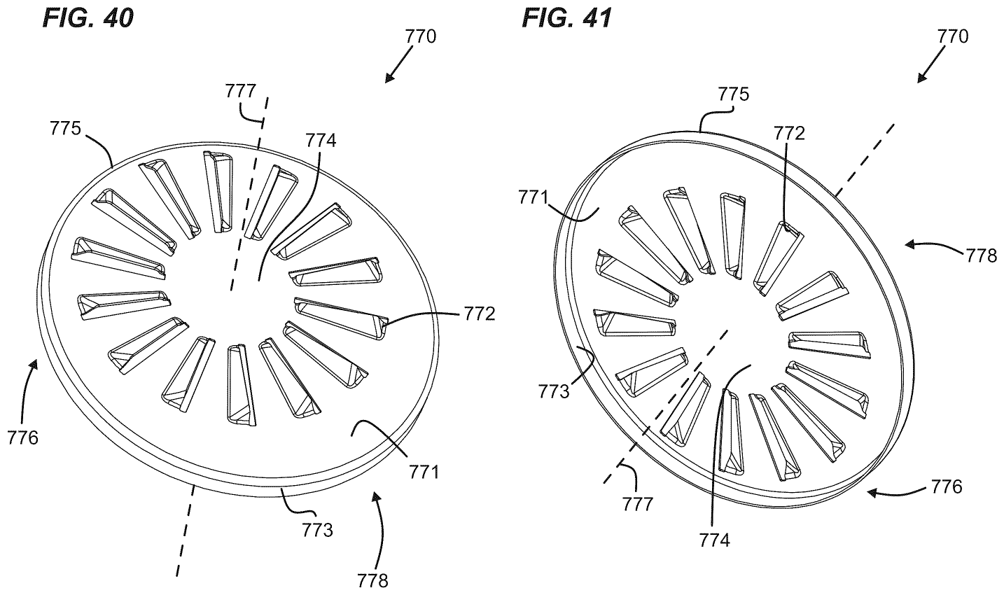

Another example swirl member 870 is shown in FIGS. 42-43. In certain examples, the swirl member 870 defines a plate 871 with a lip 873 along a perimeter 875 of the plate 871. In certain examples, the perimeter 875 is defined around an outside edge of the swirl member 870. In certain examples, the lip 873 defines a rim extending outward from and normal to a face of the plate 871. In certain examples, the lip 873 is designed fit within a channel or other retaining feature of the outer conduit 110, 410, 510.

In certain examples, the swirl member 870 includes a plurality of scoops 872. In certain examples, each of the plurality of scoops 872 are positioned radially outward from a core 874. In certain examples, the plurality of scoops 872 are evenly spaced around the core 874. In certain examples, the plurality of scoops 872 defines six scoops. In certain examples, the core 874 defines a solid portion of the swirl member 870. In certain examples, the core 874 is removable to define an opening. In certain examples, the core 874 is a circular portion of the swirl member 870. In certain examples, the core 874 is centered on the plate 871 of the swirl member 870. In certain examples, the core 874 is removable such that a cavity may be created. In certain examples, a second swirl axis 877 is defined extending centrally through the core 774. In certain examples, the second swirl axis 877 is coaxial with the longitudinal axis 116. In certain examples, the swirl member 870 defines an upper portion 876 and a lower portion 878. In certain examples, the core 874 is positioned centered between the upper portion 876 and 878.

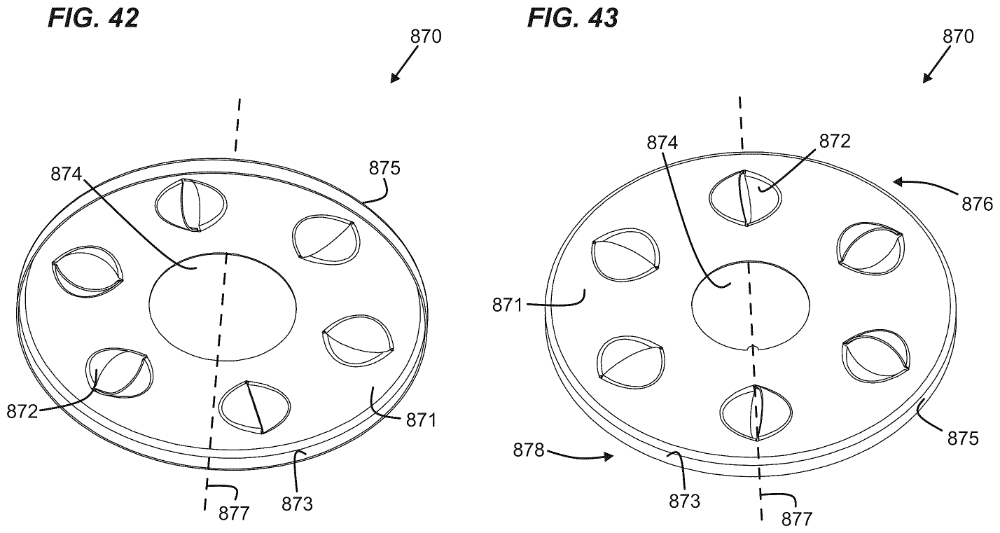

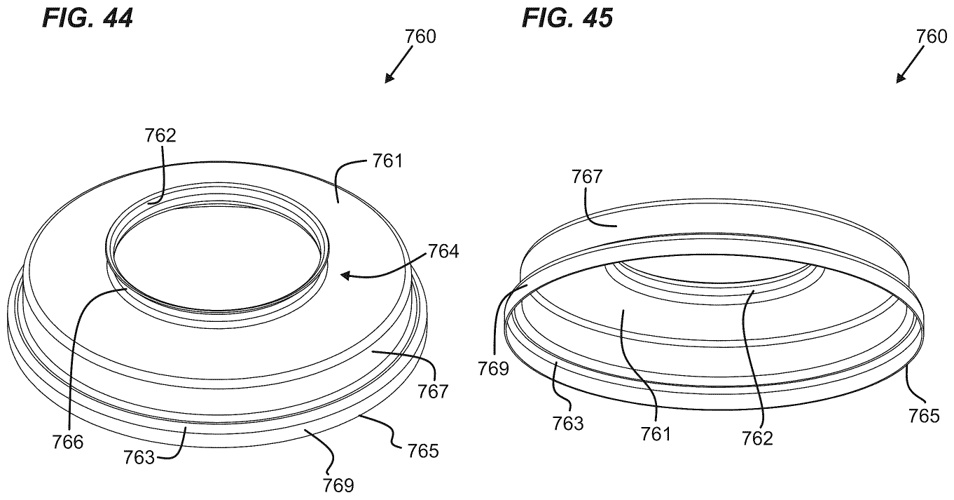

Different restrictor arrangements can be used with any of the exhaust treatment devices 100, 200, 300, 400, 500, 600 described above. FIGS. 44-49 depict additional variations of restrictor arrangements that may be used in combination with any of the above-described exhaust treatment devices. An example restrictor arrangement 760 is shown in FIGS. 44-45. In certain examples, the restrictor arrangement 760 defines a central opening 762 extending centrally through a plate 761. In certain examples, the central opening is centered on the restrictor arrangement 760. In certain examples, the central opening 762 defines a circular opening centered on the longitudinal axis 116. In certain examples, a collar 764 extends outward from the plate 761 about a perimeter of the central opening 762. In certain examples, the collar 764 extends toward the outlet 113. In certain examples, the collar includes a flared end 766 that defines a channel along the collar 764. The channel is adjacent to and surrounding the central opening 762. In certain examples, the flared end 766 can be used as an attachment mechanism for a downstream conduit or other device. In certain examples, a shoulder 763 is defined around an outer perimeter of the plate 761. In certain examples, the shoulder is offset upstream of the plate 761 by a wall 767. In certain examples the wall extends rearward from the plate 761 and continues to the shoulder 763. In certain examples, a lip 769 extends rearward upstream from an outer edge of the shoulder 763. In certain examples, the lip 769 defines a periphery of the restrictor arrangement 760. In certain examples, the lip defines a perimeter 765 of the restrictor arrangement 760. In certain examples, the shoulder 763 and lip 769 cooperate to engage the perimeter 175, 475, 775, 875 of the swirl member 170, 470, 770, 870.

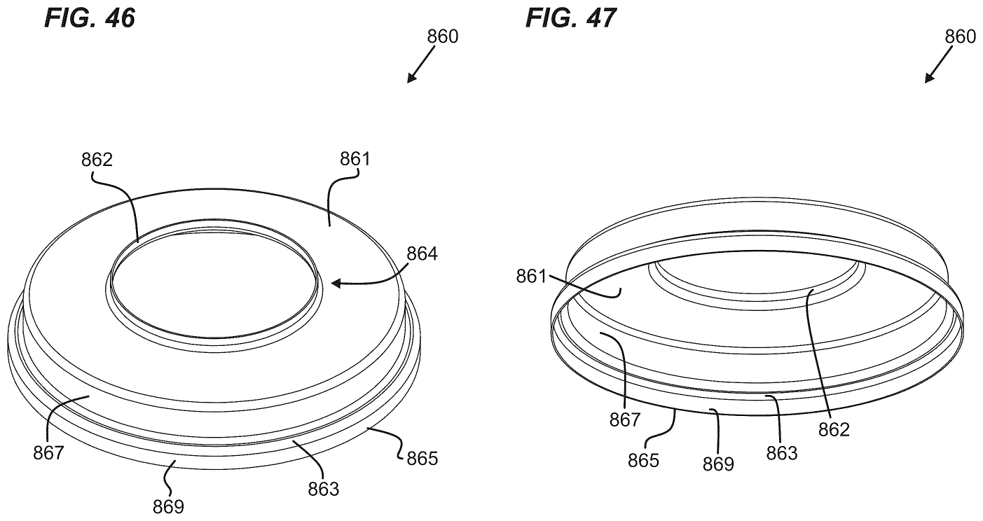

Another example restrictor arrangement 860 is shown in FIGS. 46-47. In certain examples, the restrictor arrangement 860 defines a central opening 862 extending centrally through a plate 861. In certain examples, the central opening is centered on the restrictor arrangement 860. In certain examples, the central opening 862 defines a circular opening centered on the longitudinal axis 116. In certain examples, a collar 864 extends outward from the plate 861 about a perimeter of the central opening 862. In certain examples, the collar 864 extends toward the outlet 113. In certain examples, the collar 864 can be used as an attachment mechanism for a downstream conduit or other device. In certain examples, a shoulder 863 is defined around an outer perimeter of the plate 861. In certain examples, the shoulder is offset upstream of the plate 861 by a wall 867. In certain examples the wall extends rearward from the plate 861, normal to the plate 861, and continues to the shoulder 863. In certain examples, a lip 869 extends rearward upstream from an outer edge of the shoulder 863. In certain examples, the lip 869 defines a periphery of the restrictor arrangement 860. In certain examples, the lip 869 defines a perimeter 865 of the restrictor arrangement 860. In certain examples, the shoulder 863 and lip 869 cooperate to engage the perimeter 175, 475, 775, 875 of the swirl member 170, 470, 770, 870.

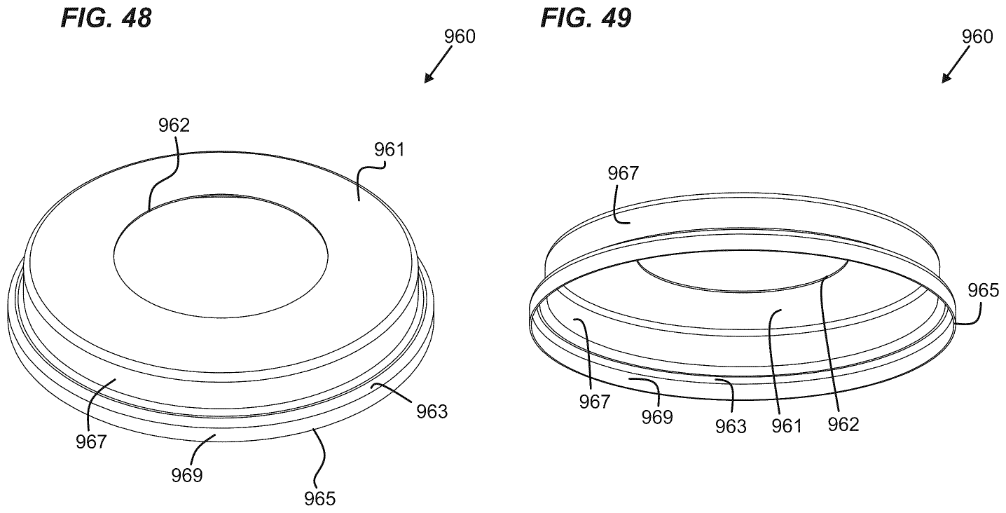

Another example restrictor arrangement 960 is shown in FIGS. 48-49. In certain examples, the restrictor arrangement 960 defines a central opening 962 extending centrally through a plate 961. In certain examples, the central opening 962 is centered on the restrictor arrangement 960. In certain examples, the central opening 962 defines a circular opening centered on the longitudinal axis 116. In certain examples, a shoulder 963 is defined around an outer perimeter of the plate 961. In certain examples, the shoulder is offset upstream of the plate 961 by a wall 967. In certain examples the wall extends rearward from the plate 961, normal to the plate 961, and continues to the shoulder 963. In certain examples, a lip 969 extends rearward upstream from an outer edge of the shoulder 963. In certain examples, the lip 969 defines a periphery of the restrictor arrangement 960. In certain examples, the lip defines a perimeter 965 of the restrictor arrangement 960. In certain examples, the shoulder 963 and lip 969 cooperate to engage the perimeter 175, 475, 775, 875 of the swirl member 170, 470, 770, 870.

In certain examples, the restrictor arrangements 760, 860, 960 provide consistent downstream spacing from swirl members, impact surfaces, and/or divider baffle. In certain examples, the restrictor arrangements 760, 860, 960 provide improved airflow through the central opening 762, 862, 962 by incrementally reducing a cross sectional area for airflow at the shoulder 763, 863, 963 before arriving at the central opening 762, 862, 962.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

1. An exhaust treatment device comprising:
an outer conduit defining a length between a first end and a second end, the outer conduit including a perimetrical wall defining an interior space and extending along the length from the first end to the second end, a longitudinal axis extending centrally through the interior space from the first end to the second end, the outer conduit having an injector mounting location, the outer conduit having an upstream portion and a downstream portion;
a divider baffle positioned within the interior space at an intermediate location between the upstream portion and the downstream portion, the divider baffle defining first, second, and third openings connecting the upstream portion with the downstream portion;
a dosing conduit positioned within the interior space in the upstream portion, the dosing conduit extending between a first duct end and a second duct end at an angle relative to the longitudinal axis, the second duct end connecting to the first opening of the divider baffle; and
a restrictor arrangement positioned in the downstream portion, the restrictor arrangement restricting exhaust airflow as the exhaust airflow travels through the outer conduit.

2. The exhaust treatment device of claim 1, wherein the divider baffle further defines a swirl pocket, wherein the first opening is within the swirl pocket.

3. The exhaust treatment device of claim 1, wherein the divider baffle further defines a front face facing the upstream portion, wherein the second opening is on the front face.

4. The exhaust treatment device of claim 1, wherein the divider baffle further defines an impact surface, wherein the impact surface extends parallel with the longitudinal axis and is positioned below the first and second openings.

5. The exhaust treatment device of claim 4, wherein the impact surface is at least partially spaced apart from an inner surface of the outer conduit such that a gap is formed.

6. The exhaust treatment device of claim 4, wherein the third opening is defined on the impact surface.

7. The exhaust treatment device of claim 1, wherein the third opening is a plurality of louvers with a first group of louvers opening toward a first side of the exhaust treatment device and a second group of louvers opening toward a second side of the exhaust treatment device.

8. The exhaust treatment device of claim 7, wherein a portion of the plurality of louvers extend below the first opening.

9. The exhaust treatment device of claim 7, wherein at least a portion of the plurality of louvers extend below a swirl pocket defined by the divider baffle.

10. The exhaust treatment device of claim 1, wherein the exhaust treatment device further includes a swirl member positioned downstream of the divider baffle, wherein the swirl member includes a plurality of openings and at least a majority of the plurality of openings are positioned on an upper portion of the swirl member.

11. The exhaust treatment device of claim 1, wherein the first, second, and third openings partially define corresponding first, second, and third fluid pathways, wherein each of the fluid pathways provides a route for a portion of the exhaust airflow to travel between the upstream portion and the downstream portion.

12. The exhaust treatment device of claim 11, wherein more than 50% of the exhaust airflow travels through the first fluid pathway.

13. The exhaust treatment device of claim 11, wherein less than 20% of the exhaust airflow travels through the second fluid pathway.

14. The exhaust treatment device of claim 11, wherein less than 20% of the exhaust airflow travels through the third fluid pathway.

15. An exhaust treatment device comprising:
an outer conduit defining a length between a first end and a second end, the outer conduit including a perimetrical wall defining an interior space and extending along the length from the first end to the second end, a longitudinal axis extending centrally through the interior space from the first end to the second end, the outer conduit having an injector mounting location, the outer conduit having an upstream portion and a downstream portion;
a divider baffle positioned within the interior space at an intermediate location between the upstream portion and the downstream portion;
a dosing conduit positioned within the interior space in the upstream portion, the dosing conduit extending between a first duct end and a second duct end at an angle relative to the longitudinal axis, the second duct end connecting to a first fluid pathway of the divider baffle;
a restrictor arrangement positioned in the downstream portion, the restrictor arrangement restricting exhaust airflow as the exhaust airflow travels through the outer conduit; and
a swirl member positioned between the divider baffle and the restrictor arrangement, the swirl member including a plurality of openings, wherein at least a majority of the plurality of openings are positioned on a first side of a central plane extending though the longitudinal axis.

16. The exhaust treatment device of claim 15, wherein the plurality of openings is a plurality of scoops, wherein a first subset of the plurality of scoops are circumferentially spaced about the upper portion, and a second, reduced subset of the plurality of scoops are positioned radially inward of the first subset of scoops.

17. The exhaust treatment device of claim 16, wherein the second subset of scoops are positioned such that at least one scoop is in a lower portion of the swirl member.

18. The exhaust treatment device of claim 15, wherein the plurality of openings swirl the exhaust airflow about a swirl axis that is parallel with but offset from the longitudinal axis.

19-21. (canceled)

22. An exhaust treatment system comprising:
an outer conduit extending along a longitudinal axis;
a divider baffle disposed within the outer conduit, the divider baffle separating the outer conduit into an upstream portion and a downstream portion;
a first fluid pathway extending through the divider baffle between the upstream and downstream portions, the first fluid pathway passing through a first set of turbulence generating members;
a second fluid pathway extending through the divider baffle between the upstream and downstream portions separate from the first fluid pathway, the second fluid pathway bypassing the turbulence generating members; and
a third fluid pathway extending through the divider baffle between the upstream and downstream portions separate from the first and second fluid pathways, the third fluid pathway passing through a second set of turbulence generating members, the second set being different from the first set, wherein the first, second, and third fluid pathways combine at the downstream portion.

23. The aftertreatment system of claim 22, wherein the divider baffle includes a front face facing the upstream portion, and wherein the divider baffle includes an impact surface extending outwardly from the front face into the downstream portion of the conduit.

24-27. (canceled)
